(19) United States
(12) Patent Application Publication
(10) Pub. No.: US 2026/0065497 A1
(43) Pub. Date: Mar. 5, 2026

(54) DISTANCE-BASED IMAGE COMBINATION

(71) Applicant: Boston Dynamics, Inc., Waltham, MA (US)

(72) Inventors: Hans Kumar, Somerville, MA (US); Leon He, Arlington, MA (US)

(21) Appl. No.: 19/315,273

(22) Filed: Aug. 29, 2025

Related U.S. Application Data
(60) Provisional application No. 63/689,403, filed on Aug. 30, 2024.

(51) Int. Cl. G06T 7/593; G01B 11/22; G06T 7/521; G08B 21/18

(52) U.S. Cl. CPC G06T 7/593; G01B 11/22; G06T 7/521; G08B 21/18; G06T 2207/10012; G06T 2207/10028; G06T 2207/20221

(57) ABSTRACT

Systems and methods are described for combining sensor data obtained by a mobile robot. A system can obtain first sensor data from one or more first sensors of a robot. The system can determine a distance between the robot and at least a portion of the environment based on the first sensor data. For example, the distance may be a depth from a depth map. The system can obtain second sensor data from one or more second sensors of the robot. The system can combine a first portion of the second sensor data and a second portion of the second sensor data based on the distance. For example, the system can use the distance to determine a seam for combination of the first image and the second image. The system can instruct output of a user interface based on the combination.

### CROSS REFERENCE TO RELATED APPLICATION

This U.S. patent application claims priority under 35 U.S.C. § 119 (e) to U.S. Provisional Application No. 63/689,403, filed Aug. 30, 2024, which is considered part of the disclosure of this application and is hereby incorporated by reference in its entirety.

### TECHNICAL FIELD

This disclosure relates generally to robotics, and more specifically, to systems, methods, and apparatus, including computer programs, for combining images.

### BACKGROUND

Robotic devices can autonomously or semi-autonomously navigate environments to perform a variety of tasks or functions. As robotic devices become more prevalent, there is a need to obtain and/or generate image data based on the navigation of the environments and display the image data.

### SUMMARY

An aspect of the present disclosure provides a method. The method may include obtaining, by data processing hardware of a robot, sensor data associated with an environment of the robot. The method may further include determining, by the data processing hardware, a distance between the robot and at least a portion of the environment based on the sensor data. The method may further include obtaining, by the data processing hardware, image data associated with the environment. The image data may include a first image and a second image. The method may further include combining, by the data processing hardware, the first image and the second image to obtain combined image data. The combined image data may be based on the distance. The method may further include instructing, by the data processing hardware, output of a user interface based on the combined image data.

In some embodiments, the method may include adjusting how images, associated with a robot (e.g., a complex robot with limited compute), are combined to reduce an amount of parallax in a combined image by placing a seam of the images in a location (e.g., a smart location) that is predicted to result in less parallax as compared to other locations.

In various embodiments, the method may further include adjusting the combined image data based on the distance.

In various embodiments, the method may further include adjusting a third image based on the distance to obtain the first image or the second image.

In various embodiments, the method may further include generating an alert associated with the combined image data based on the distance.

In various embodiments, the method may further include generating an alert associated with a portion of the first image or a portion of the second image based on the distance.

In various embodiments, the method may further include generating a first alert associated with a portion of the first image based on the distance. The method may further include generating a second alert associated with a portion of the second image based on the distance.

In various embodiments, the method may further include flagging a portion of the combined image data.

In various embodiments, the distance may include a first distance. The method may further include determining a second distance between the robot and the at least a portion of the environment based on the sensor data. The combined image data may be based on the first distance and the second distance.

In various embodiments, the distance may include a first distance. The method may further include determining a second distance between the robot and the at least a portion of the environment based on the sensor data. The method may further include determining a third distance based on the first distance and the second distance. Combining the first image and the second image may be based on the third distance.

In various embodiments, the distance may include a first distance. The method may further include determining a second distance between the robot and the at least a portion of the environment based on the sensor data. The method may further include determining that the first distance is different from the second distance. Combining the first image and the second image may be based determining that the first distance is different from the second distance.

In various embodiments, the distance may include a first distance. The method may further include determining a second distance between the robot and the at least a portion of the environment based on the sensor data. The method may further include comparing the first distance and the second distance. The method may further include verifying the second distance based on comparing the first distance and the second distance. Combining the first image and the second image may be based on verifying the second distance.

In various embodiments, the distance may include a first distance. The method may further include generating a first map based on the sensor data. The first map may indicate the first distance. The method may further include obtaining a second map based on the image data. The second map may indicate a second distance. Combining the first image and the second image may be based on the first map and the second map.

In various embodiments, the method may further include determining, by the data processing hardware, a plurality of distances. Each distance of the plurality of distances may include a measurement of a respective depth from the robot and to a respective at least a portion of the environment. The plurality of distances may include the distance. The combined image data may be based on the plurality of distances.

In various embodiments, the method may further include determining, by the data processing hardware, a plurality of distances. Each distance of the plurality of distances may include a measurement of a respective depth from the robot and to a respective at least a portion of the environment based on at least one of the sensor data or the image data. The plurality of distances may include the distance. The combined image data may be based on the plurality of distances.

In various embodiments, the distance may include a first distance. The method may further include generating a first map based on the sensor data. The first map may indicate the first distance. The method may further include obtaining a second map based on the image data. The second map may indicate a second distance. The method may further include generating a third map based on the first map and the second map. The combined image data may be based on the third map.

In various embodiments, the distance may include a first distance. The method may further include generating a first map based on the sensor data. The first map may indicate the first distance. The method may further include obtaining a second map based on the image data. The second map may indicate a second distance. The method may further include determining one or more mapping parameters based on the first map and the second map. The method may further include generating a third map based on the one or more mapping parameters. The combined image data may be based on the third map.

In various embodiments, the method may further include generating a first map based on the sensor data. The first map may indicate a first distance. The method may further include obtaining a second map based on at least one of the sensor data or the image data. The second map may indicate a second distance. The second distance may include a rough distance estimate. The distance may be based on the first distance and the second distance.

In various embodiments, the method may further include generating a first map based on the sensor data. The first map may indicate a first distance. The method may further include obtaining a second map based on at least one of the sensor data or the image data. The second map may indicate a rough distance estimate. The rough distance estimate may be generated by a monocular depth network. Determining the distance may include revising the rough distance estimate based on at least one of the sensor data, the image data, or the first distance, or a second distance.

In various embodiments, obtaining the sensor data may include obtaining the sensor data from one or more first image sensors of the robot. Obtaining the image data may include obtaining the image data from one or more second image sensors of the robot. The method may further include generating a first map based on the sensor data. The first map may indicate a first distance. The method may further include obtaining a second map based on the image data. The second map may indicate a second distance. The method may further include determining a correlation between the one or more first image sensors and the one or more second image sensors. The method may further include correlating the first map and the second map based on the correlation between the one or more first image sensors and the one or more second image sensors. The method may further include determining one or more mapping parameters based on correlating the first map and the second map. The method may further include generating a third map based on the one or more mapping parameters. The combined image data may be based on the third map.

In various embodiments, obtaining the sensor data may include obtaining the sensor data from one or more first image sensors of the robot. Obtaining the image data may include obtaining the image data from one or more second image sensors of the robot. The distance may include a first distance. The one or more first image sensors may have a first field of view. The one or more second image sensors may have a second field of view. The first field of view may be a portion of the second field of view. The method may further include generating a first map based on the sensor data. The first map may indicate the first distance. The method may further include obtaining a second map based on the image data. The second map may indicate a second distance. The method may further include generating a third map based on the first map and the second map. The combined image data may be based on the third map.

In various embodiments, obtaining the sensor data may include obtaining the sensor data from one or more first image sensors of the robot. Obtaining the image data may include obtaining the image data from one or more second image sensors of the robot. The distance may include a first distance. The one or more first image sensors may have a first field of view. The one or more second image sensor mays have a second field of view. The first field of view may include a first portion of the second field of view and may exclude a second portion of the second field of view. The method may further include generating a first map based on the sensor data. The first map may indicate the first distance. The method may further include obtaining a second map based on the image data. The second map may indicate a second distance. The method may further include generating a third map based on the first map and the second map. The combined image data may be based on the third map.

In various embodiments, combining the first image and the second image may include projecting the first image and the second image onto a three-dimensional representation based on the distance. Combining the first image and the second image may further include generating an equirectangular panorama based on projecting the first image and the second image onto the three-dimensional representation. The user interface may include the equirectangular panorama.

In various embodiments, the method may further include instructing movement of the robot such that a seam between the sensor data and the image data corresponds to the at least a portion of the environment.

In various embodiments, the at least a portion of the environment may include a first portion of the environment. Obtaining the image data may include obtaining the first image from a first image sensor and the second image from a second image sensor. The method may further include determining that the first portion of the environment is further from the robot as compared to a second portion of the environment. The method may further include instructing movement of the robot such that a seam between the sensor data and the image data corresponds to the first portion of the environment.

In various embodiments, obtaining the image data may include obtaining the first image from a first image sensor and the second image from a second image sensor. The method may further include instructing movement of at least one of the first image sensor or the second image sensor such that a seam between the first image and the second image corresponds to the at least a portion of the environment.

In various embodiments, obtaining the image data may include obtaining the first image from a first image sensor and the second image from a second image sensor. The method may further include instructing movement, in real-time, of at least one of the first image sensor or the second image sensor as the robot navigates the environment such that a seam between the first image and the second image corresponds to the at least a portion of the environment.

In various embodiments, the at least a portion of the environment may include a first portion of the environment. Obtaining the image data may include obtaining the first image from a first image sensor and the second image from a second image sensor. The method may further include determining that the first portion of the environment is further from the robot as compared to a second portion of the environment. The method may further include instructing movement of at least one of the first image sensor or the second image sensor such that a seam between the first image and the second image corresponds to the first portion of the environment.

In various embodiments, determining the distance may include determining the distance based on the sensor data and the image data.

In various embodiments, the method may further include moving a seam between the first image and the second image such that the seam corresponds to the at least a portion of the environment.

In various embodiments, the at least a portion of the environment may include a first portion of the environment. The method may further include determining that the first portion of the environment is further from the robot as compared to a second portion of the environment. The method may further include moving a seam between the first image and the second image that corresponds to the second portion of the environment such that the seam corresponds to the first portion of the environment.

In various embodiments, the method may further include identifying an artifact within the combined image data based on the distance.

In various embodiments, obtaining the sensor data may include obtaining the sensor data from one or more first image sensors of the robot. Obtaining the image data may include obtaining the image data from one or more second image sensors of the robot.

In various embodiments, obtaining the sensor data may include obtaining the sensor data from one or more first image sensors of the robot. Obtaining the image data may include obtaining the image data from five second image sensors of the robot. The five second image sensors may operate at thirty frames or more per second.

In various embodiments, obtaining the sensor data may include obtaining the sensor data from a first image sensor of the robot. The distance may include a distance between the first image sensor and the at least a portion of the environment.

In various embodiments, obtaining the sensor data may include obtaining the sensor data from a first image sensor of the robot. A field of view of the first image sensor may include at least a portion of a ground surface of the environment.

In various embodiments, obtaining the sensor data may include obtaining the sensor data from a time-of-flight image sensor.

In various embodiments, obtaining the sensor data may include obtaining the sensor data from a lidar sensor.

In various embodiments, obtaining the sensor data may include obtaining the sensor data from a stereo depth image sensor.

In various embodiments, obtaining the image data may include obtaining the first image from a first image sensor and the second image from a second image sensor. A field of view of the first image sensor may overlap with a field of view of the second image sensor.

In various embodiments, obtaining the image data may include obtaining the first image from a first image sensor and the second image from a second image sensor. The first image sensor and the second image sensor may be separated by a translation.

In various embodiments, the first image and the second image may cause a parallax.

In various embodiments, obtaining the image data may include obtaining the first image from a first image sensor and the second image from a second image sensor. The image data may be associated with a non-planar scene.

In various embodiments, combining the first image and the second image may include performing image stitching.

In various embodiments, combining the first image and the second image may include stitching the first image and the second image.

In various embodiments, the method may further include generating a map based on the sensor data. The map may indicate the distance.

In various embodiments, the method may further include generating a depth map based on the sensor data. The depth map may indicate the distance.

In various embodiments, the method may further include generating a voxel map based on the sensor data. The voxel map may indicate the distance.

In various embodiments, the sensor data and the image data may be associated with different portions of the environment.

In various embodiments, the at least a portion of the environment may include a ground surface of the environment.

In various embodiments, the at least a portion of the environment may include an object within the environment.

According to various embodiments of the present disclosure, a system may include data processing hardware and memory in communication with the data processing hardware. The memory may store instructions that when executed on the data processing hardware cause the data processing hardware to obtain sensor data associated with an environment of a robot. Execution of the instructions may further cause the data processing hardware to determine a distance between the robot and at least a portion of the environment based on the sensor data. Execution of the instructions may further cause the data processing hardware to obtain image data associated with the environment. The image data may include a first image and a second image. Execution of the instructions may further cause the data processing hardware to combine the first image and the second image to obtain combined image data. The combined image data may be based on the distance. Execution of the instructions may further cause the data processing hardware to instruct output of a user interface based on the combined image data.

In various embodiments, the system may further include any combination of the features discussed herein.

According to various embodiments of the present disclosure, a robot may include data processing hardware and memory in communication with the data processing hardware. The memory may store instructions that when executed on the data processing hardware cause the data processing hardware to obtain sensor data associated with an environment of the robot. Execution of the instructions may further cause the data processing hardware to determine a distance between the robot and at least a portion of the environment based on the sensor data. Execution of the instructions may further cause the data processing hardware to obtain image data associated with the environment. The image data may include a first image and a second image. Execution of the instructions may further cause the data processing hardware to combine the first image and the second image to obtain combined image data. The combined image data may be based on the distance. Execution of the instructions may further cause the data processing hardware to instruct output of a user interface based on the combined image data.

In various embodiments, the robot may further include any combination of the features discussed herein.

According to various embodiments of the present disclosure, a method may include obtaining, by data processing hardware of a robot, a map. The map may indicate a distance between the robot and at least a portion of an environment of the robot. The method may further include obtaining, by the data processing hardware, image data associated with the environment. The method may further include combining, by the data processing hardware, based on the distance, a first image of the image data and a second image of the image data to obtain a combined image. The method may further include instructing, by the data processing hardware, display of the combined image.

In various embodiments, the method may further include any combination of the features discussed herein.

According to various embodiments of the present disclosure, a method may include obtaining, by data processing hardware of a robot, a map indicating a distance between the robot and at least a portion of an environment of the robot. The method may further include obtaining, by the data processing hardware, image data associated with the environment. The method may further include combining, by the data processing hardware, a first image of the image data and a second image of the image data to obtain a combined image. The method may further generating an alert based on one or more of the combined image or the distance The method may further include instructing, by the data processing hardware, display of the alert.

In various embodiments, the method may further include any combination of the features discussed herein.

According to various embodiments of the present disclosure, a method may include determining, by data processing hardware of a robot, a distance between the robot and at least a portion of an environment. The method may further include obtaining, by the data processing hardware, image data associated with the environment. The image data may include a first image and a second image. The first image and the second image may be separated by a seam. The method may further include moving, by the data processing hardware, the seam based on the distance to obtain a modified first image and a modified second image. The method may further include combining, by the data processing hardware, the modified first image and the modified second image to obtain a combined image. The method may further include instructing, by the data processing hardware, output of a user interface based on the combined image.

In various embodiments, the method may further include any combination of the features discussed herein.

According to various embodiments of the present disclosure, a method may include determining, by data processing hardware of a robot, a distance between the robot and at least a portion of an environment. The method may further include obtaining, by the data processing hardware, sensor data associated with the environment. The sensor data may include a first image and a second image. The first image and the second image may be separated by a seam. The method may further include instructing, by the data processing hardware, movement of the robot such that the seam corresponds to the at least a portion of the environment. The method may further include obtaining, by the data processing hardware, image data based on instructing movement of the robot. The image data may include a third image and a fourth image. The method may further include combining, by the data processing hardware, the third image and the fourth image to obtain a combined image. The method may further include instructing, by the data processing hardware, output of a user interface based on the combined image.

In various embodiments, the method may further include any combination of the features discussed herein.

According to various embodiments of the present disclosure, a method may include obtaining, by data processing hardware of a robot, a map. The map may indicate a first distance between the robot and at least a portion of an environment of the robot. The method may further include obtaining, by the data processing hardware, image data associated with the environment. The method may further include determining, by the data processing hardware, a second distance between the robot and the at least a portion of the environment based on the image data. The method may further include combining, by the data processing hardware, based on the first distance and the second distance, a first image of the image data and a second image of the image data to obtain combined image data. The method may further include instructing, by the data processing hardware, output of a user interface based on the combined image data.

In various embodiments, the method may further include any combination of the features discussed herein.

According to various embodiments of the present disclosure, a method may include obtaining, by data processing hardware of a robot, a first map. The first map may indicate a first distance between the robot and at least a portion of an environment of the robot. The method may further include obtaining, by the data processing hardware, a second map. The second map may indicate a second distance between the robot and the at least a portion of the environment. The method may further include obtaining, by the data processing hardware, image data associated with the environment. The method may further include determining, by the data processing hardware, a distance between the robot and the at least a portion of the environment based on the first map and the second map. The method may further include combining, by the data processing hardware, a first image of the image data and a second image of the image data to obtain combined image data based on the distance. The method may further include instructing, by the data processing hardware, output of a user interface based on the combined image data.

In various embodiments, the method may further include any combination of the features discussed herein.

According to various embodiments of the present disclosure, a system may include data processing hardware and memory in communication with the data processing hardware. The memory may store instructions that when executed on the data processing hardware cause the data processing hardware to perform any combination of the features discussed herein.

According to various embodiments of the present disclosure, a mobile robot may include at least one sensor, at least two legs, data processing hardware, and memory in communication with the data processing hardware. The memory may store instructions that when executed on the data processing hardware cause the data processing hardware to perform any combination of the features discussed herein.

### DESCRIPTION OF DRAWINGS

FIG. 1A is a schematic view of an example robot for navigating about an environment.

FIG. 1B is a schematic view of one embodiment of a sensor pointing system for pointing a sensor of the robot of FIG. 1A.

FIG. 2 is a schematic view of a robot with a sensor pointing system according to one embodiment.

FIG. 3 is a schematic view of a robot navigating to a point of interest to capture sensor data according to one embodiment.

FIG. 4 is a schematic view of a sensor pointing system according to one embodiment.

FIG. 5 is a schematic view of an environment of the robot of FIG. 1A.

FIG. 6 is a schematic view of an example system of the robot of FIG. 1A.

FIG. 7 is a schematic view of a robot in an environment.

FIG. 8A is a schematic view of an example of sensor data for combination.

FIG. 8B is a schematic view of another example of sensor data for combination.

FIG. 8C is a schematic view of an example of data for determination of a distance.

FIG. 8D is a schematic view of an example of combined sensor data.

FIG. 9 is a flowchart of an example arrangement of operations for combining data.

FIG. 10 is a schematic view of an example computing device that may be used to implement the systems and methods described herein.

Like reference symbols in the various drawings indicate like elements.

### DETAILED DESCRIPTION

Generally described, autonomous and semi-autonomous robots (e.g., mobile robots, legged robots, etc.) can capture data (e.g., robot data, mobile robot data, etc.) associated with the robots. The data may correspond to (e.g., may represent) an environment of a robot. For example, the data may be a two-dimensional representation of a three-dimensional environment of the robot. In another example, the data may be a measurement of the environment of the robot.

In some cases, the robots can capture the data as the robots traverse the environment. For example, the robots can capture the data as the robots actively traverse the environment. In some cases, the robots can capture the data before or after the robots traverse the environment. For example, the robots can traverse the environment to a first location within the environment, obtain data associated with the first location, traverse the environment to a second location within the environment, obtain data associated with the second location, etc.

A robot can obtain the data (e.g., sensor data) from one or more components of the robot (e.g., sensors, sources, outputs, etc.). For example, the robot can obtain sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a clock, and/or any other component of the robot. Further, the sensor data may include image data, lidar data, ladar data, radar data, pressure data, acceleration data, battery data (e.g., voltage data), speed data, position data, orientation data, pose data, tilt data, time data, temperature data, etc. For example, the data may include image data that further includes a plurality of images. It will be understood that while reference may be made herein to sensor data or image data, any data associated with the robot can be utilized.

All or a portion of the components may have a different pose, orientation, rotation, translation, etc. All or a portion of the components may have a particular location on (e.g., may be affixed to) a robot, a separate system, etc. For example, a first component may be located on a left side of a robot, a second component may be located on a right side of the robot, a third component may be located on a top side of the robot (e.g., the top side facing away from a ground surface of the robot during traversal of an environment by the robot), a fourth component may be located on a front portion of the robot (e.g., a face of the robot), etc. In another example, a first component may be located on a left side of the robot and oriented in a first direction and a second component may be located on the left side of the robot and oriented in a second direction.

In some cases, all or a portion of the components may be located remotely from the robot. For example, all or a portion of the components may be located separately from the robot within the environment (e.g., the components may include a camera that is not located on the robot and is located separately within the environment).

In some cases, the location, pose, orientation, rotation, translation, etc. of a component may change (e.g., based on movement of the robot, movement of the component, movement within the environment, etc.). For example, a user may manually adjust an orientation of a component, a system may instruct automatic adjustment of a rotation of a component (e.g., with or without also adjusting a location, pose, orientation, rotation, translation, etc. of a body of the robot), etc.

In some cases, the robot may obtain all or a portion of the sensor data from multiple components (e.g., of the robot). For example, the robot may obtain a first portion of the sensor data from a first component (e.g., a first image sensor), a second portion of the sensor data from a second component (e.g., a second image sensor), etc.

In some cases, the robot may obtain all or a portion of the sensor data from a single component. For example, the robot may obtain a first portion of the sensor data from a component captured during a first time period and a second portion of the sensor data from a component captured during a second time period.

A first portion of the sensor data may correspond to (e.g., may overlap with) a second portion of the sensor data. The robot may combine (e.g., join, adjoin, stitch, merge, mix, warp, etc.) the first and second portions of the sensor data (e.g., data from multiple components, data from the same component captured during different time periods, etc.) to obtain combined sensor data based on the correspondence between the first and second portions of the sensor data. For example, the robot may combine image data via image stitching to obtain a panorama image (e.g., a 360 degree panorama image) and/or high-resolution image.

The robot may determine that the sensor data can be combined based on a location, pose, orientation, rotation, etc. of one or more components providing the sensor data. For example, the robot may determine that a first component and a second component located on a front portion of a body of the robot are providing the sensor data. Based on determining the location, pose, orientation, rotation, etc. of the first component and the second component, the robot can determine that the sensor data provided by the first component and the second component can be combined to obtain combined sensor data. For example, the robot may determine that a first portion of the sensor data and a second portion of the sensor data can be combined based on determining that the first portion of the sensor data is obtained from a first component and the second portion of the sensor data is obtained from a second component that are located at a same or similar location (e.g., are located on a front portion of the robot, are located on a top portion of the robot, etc.), are oriented in a same direction (e.g., that are facing forward relative to a body of the robot), etc.

In some cases, the robot may obtain an indication that particular sensor data is to be combined. For example, the robot may obtain, from a user computing device, an indication that sensor data from a first sensor is to be combined with sensor data from a second sensor.

To combine the sensor data, the robot can identify a relationship (e.g., a transformation) between the first and second portions of the sensor data. In some cases, the robot may determine that the sensor data can be combined based on feature points (e.g., reference points, pixels, etc.) within the sensor data. For example, the robot may identify a first set of feature points within a first portion of the sensor data and a second set of feature points within a second portion of the sensor data. The robot may use a first set of feature points of the first portion of the sensor data and a second set of feature points of the second portion of the sensor data to identify the relationship between the first and second portions of the sensor data. Using the relationship, the robot can combine the sensor data to obtain a combined sensor data.

In some cases, the robot may match the feature points within the first and second portions of the sensor data and determine an amount of the first set of feature points that correspond to feature points of the second set of feature points. The robot may determine whether the amount satisfies (e.g., is greater than, matches, or is within) a threshold (e.g., a threshold value, a threshold range, etc.) or a set of two or more thresholds and based on determining that the amount is greater than, matches, or is within the threshold(s), the robot may determine that the first portion of the sensor data and the second portion of the sensor data can be combined.

In some cases, to combine the sensor data into combined sensor data, the robot may determine a distance associated with the environment. For example, the distance may be a fixed or variable distance. The robot can combine the sensor data according to a particular distance by projecting the sensor data to a sphere (e.g., a three-dimensional sphere) having a particular radius (e.g., a stitching radius) such that the distance of the objects, obstacles, structures, and/or entities in the environment is the same and by unprojecting the sensor data from the sphere to a two-dimensional representation to obtain the combined sensor data (e.g., a two-dimensional panoramic representation). In some cases, the radius may be a fixed radius or a variable radius (for instance, a different radius for each pixel in a panorama). In some cases, as discussed herein, combined sensor data generated using a fixed radius may exclude (e.g., not represent) portions of the environment if the radius is too large relative to the sensor data or may include artifacts if the radius is too small relative to the sensor data.

The combined sensor data may include a seam (e.g., based on the radius) between a first portion of the sensor data and a second portion of the sensor data (e.g., between images). For example, the seam may indicate where the first portion of the sensor data and the second portion of the sensor data are combined to obtain the combined sensor data.

In some cases, the robot can blend (e.g., perform image blending on) the combined sensor data at the seam. Based on the combination of the sensor data (e.g., the placement of the seam, the performance of image blending, the radius, etc.), the combined sensor data may include one or more artifacts (e.g., indicating objects, obstacles, entities, and/or structures that are not present in the environment at least as indicated by the combined sensor data or are present in the environment but are mislocated within the combined sensor data). For example, artifacts may be anomalies (e.g., distortions, ghosting artifacts, etc.) within a virtual representation of an environment. Further, artifacts may not represent an object, entity, obstacle, and/or structure that is present in the environment or may represent, incorrectly, an object, entity, obstacle, and/or structure that is present in the environment. In some cases, the artifacts may be associated with an outline of an object, entity, obstacle, and/or structure that is present in the environment (e.g., misrepresenting the outline). Such artifacts may cause blurring and/or ghosting within an image.

The inclusion of such artifacts within the combined sensor data may cause issues and/or inefficiencies (including computational inefficiencies, a loss of confidence in the systems and/or the robot, etc.). For example, a system may provide the combined sensor data (including artifacts) to a user computing device and a user may be unable to identify an accurate representation of the environment of the robot due to the artifacts.

Artifacts may be generated when a first portion of the sensor data and a second portion of the sensor data that are to be combined are obtained from one or more sensors having different translations, rotations, orientations, poses, etc. For example, based on the different translations, rotations, orientations, poses, etc. (e.g., based on a parallax) relative to an object, structure, obstacle, and/or entity within the environment, the combined sensor data may include artifacts associated with the object, structure, obstacle, and/or entity.

The present disclosure relates to combining sets of sensor data (e.g., panorama stitching of two or more images) to obtain combined sensor data and/or adjusting the combined sensor data based on a distance (e.g., a depth, a depth estimate, etc.) associated with a robot (e.g., by adjusting a stitching algorithm according to the distance) to reduce a number of artifacts within the combined sensor data while capturing the objects, entities, obstacles, etc. within the environment. For example, a computing system may adjust one or more first distances associated with the sets of sensor data (e.g., on a camera by camera basis) based on one or more second distances and may combine the adjusted sets of sensor data. In another example, a computing system may combine the sets of sensor data and adjust one or more first distances associated with the combined sensor data based on the one or more second distances. In some cases, the computing system may combine (e.g., fuse) the one or more first distances and the one or more second distances.

The distance can indicate a distance between the robot (e.g., a body of the robot, a component of the robot, etc.) and a portion of the environment (e.g., an obstacle, an object, an entity, a structure, and/or a ground surface within the environment). In some cases, the distance may be based on sensor data from one or more sensors. For example, the distance may be based on first sensor data from one or more first sensors and second sensor data from one or more second sensors.

As discussed herein, the computing system may obtain sensor data from one or more sensors for combination. As the computing system may obtain the sensor data for combination from one or more sensors that have different poses, orientations, rotations, translations, etc., the resulting combined sensor data may include artifacts (e.g., parallax errors).

In some cases, a user may attempt to manually review the combined sensor data and identify artifacts based on the manual review. However, such a manual review of the combined sensor data may not be possible as a robot may generate a large amount of data. Further, a user may be located separately from the robot and may be unable to identify what is an artifact and what is not an artifact. Such a manual process may cause issues and/or inefficiencies (e.g., movement inefficiencies) and may be resource and time intensive and inefficient based on the amount of data associated with a robot(s).

The methods and apparatus described herein enable a computing system to dynamically combine sensor data based on a determined distance. As robots proliferate, the demand for accurate and complete representations of an environment of the robots (e.g., panoramic representations) has increased. Specifically, the demand for robots to provide such representations that do not include artifacts or include a decreased number of artifacts has increased. The present disclosure provides systems and methods that enable an increase in the accuracy and efficiency in the combination of data (e.g., using a determined distance). For example, the systems and methods can combine sensor data with a low latency (e.g., less than 100 milliseconds) on two or more images (e.g., five or more images) at a high resolution (e.g., 1920 pixels by 1080 pixels or higher) and a high frequency (e.g., 30 frames per second or greater).

To combine sensor data, the computing system can obtain first sensor data (e.g., first image data, distance data, etc.). For example, the computing system can obtain the first sensor data from one or more first sensors (e.g., a first set of images from a first sensor, a second set of images from a second sensor, etc.).

Using the first sensor data, the computing system can determine a first distance between the robot and the portion of the environment. To determine the first distance, the computing system (e.g., using a perception system) can generate a first map (e.g., a voxel map, a depth map, a spherical depth map, etc.). The computing system can generate the first map from the first sensor data (e.g., image data, odometry data, etc.). The first map may be based on (e.g., may be associated with) a one or more reference frames of the robot (e.g., a world reference frame, a local reference frame, etc.). For example, the computing system can obtain odometry data associated with the robot to define a location of the robot (e.g., by position and/or velocity of a body of the robot) based on a world reference frame of the robot. In another example, the computing system can obtain image data to define an area within range of the one or more sensors based on a local reference frame of the robot. Using the first sensor data, the computing system can generate the first map representing the environment of the robot.

As discussed above, the first map may be a representation of the environment. For example, the first map may be a representation of the environment as a set of voxels (e.g., three-dimensional representations of a pixel) or a set of segments (e.g., two or more voxels).

In some cases, the first map may indicate a first distance to a portion of the environment. For example, the first map may indicate a first distance to an obstacle, object, structure, or entity within the environment. In some cases, the first map may include one or more cells and all or a portion of the one or more cells may include or may indicate a first distance (e.g., a distance to an obstacle, object, structure, or entity). For example, the first map may indicate a plurality of first distances. In some cases, based on an orientation of the one or more first sensors (and a corresponding field of view), the first map may include an incomplete representation of the environment.

The computing system can obtain second sensor data (e.g., second image data). For example, the computing system can obtain the first sensor data from one or more first sensors and the second sensor data from one or more second sensors. The first sensor data and the second sensor data may be associated with different portions of the environment (e.g., the one or more first sensors may have a first field of view and the one or more second sensors may have a second field of view that includes the first field of view and/or is larger than the first field of view). In some cases, the one or more first sensors may be oriented towards the ground (e.g., facing, at least partially, the ground surface) and the one or more second sensors may be oriented in a horizontal manner (e.g., parallel to the ground surface).

In some cases, the computing system (or a separate system) may process the second sensor data to identify a second distance. For example, the computing system may process the second sensor data using a depth algorithm (e.g., a monocular depth algorithm) to identify the second distance. In some cases, the computing system (or a separate system) may implement a machine learning model (e.g., a monocular depth neural network) and the computing system may provide the sensor data to the machine learning model as an input and obtain the second distance as an output of the machine learning model. For example, the second distance may be part of a depth map. In some cases, the computing system may process the second sensor data to identify a plurality of second distances.

In some cases, the computing system may process the second sensor data to generate a second map (e.g., a second depth map). For example, the machine learning model may output a depth map based on the input of the second sensor data.

Using the first distance and the second distance (or the first map and the second map), the computing system can identify a distance between the robot and the portion of the environment. For example, the computing system can average the first distance and the second distance to identify the distance.

In some cases, the first map may be an incomplete representation of the environment but may include an accurate scale and the second map may include a more complete representation of the environment as compared to the first map but may include a less accurate scale as compared to the first map. To account for the differences between the first map and the second map and determine the distance, the computing system can determine a scale using the first distance (or the first map), transform the second distance (or the second map) using the determined scale, and determine the distance using the transformed second distance (or the transformed second map).

In some cases, the computing system (or a separate system) may determine the distance by implementing a machine learning model (e.g., a neural network) and providing the first sensor data and the second sensor data (or the first map and the second map) to the machine learning model as an input. The computing system may obtain the distance as an output of the machine learning model.

The computing system can combine data (e.g., the second sensor data, additional sensor data obtained from the one or more second sensors, etc.) to obtain combined sensor data. In some cases, the computing system may adjust sensor data (e.g., adjust one or more distances associated with the sensor data) based on the determined distance (e.g., and the one or more distances associated with the sensor data) and may combine the adjusted sensor data to obtain the combined sensor data.

In some cases, the computing system may combine the sensor data and adjust the combined sensor data (e.g., adjust one or more distances associated with the combined sensor data) based on the determined distance (e.g., and the one or more distances associated with the combined sensor data). As discussed herein, the computing system can use the determined distance to identify artifacts within the combined sensor data. For example, using the determined distance, the computing system may determine that a first portion of the combined sensor data includes an artifact and flag the first portion of the combined sensor data. In some cases, the computing system can project pixels from the combined sensor data to a particular distance using the determined distance. For example, the computing system can adjust a distance of the combined sensor data using the determined distance.

In some cases, the computing system can determine the second distance from the combined sensor data (e.g., by combining the second sensor data prior to determining the second distance). For example, the computing system can combine the second sensor data to obtain combined sensor data, determine the second distance using the combined sensor data, identify the distance based on the determined second distance and a first distance (e.g., based on first sensor data), and adjust the combined sensor data (e.g., by adjusting the second distance) based on the identified distance.

In some cases, the computing system can provide the combined sensor data (e.g., with the artifacts removed) to a user computing device. For example, the computing system may provide the combined sensor data for display via a user interface of a user computing device. The combined sensor data may include a panoramic view of an environment of the robots (e.g., indicating obstacles, structures, objects, or entities within the environment of the robots).

In some cases, the computing system can utilize a variable or dynamic radius to combine the sensor data. For example, the computing system can determine a variable or dynamic radius of a sphere using the determined distance and may use the variable or dynamic radius to combine the sensor data. In another example, the computing system can determine a spatially varying warp to combine the sensor data.

The computing system can determine a particular location for placement of a seam between a first portion of the sensor data and a second portion of the sensor data using the determined distance to combine the first portion of the sensor data and a second portion of the sensor data.

In some cases, the computing system can utilize a dynamic or variable seam (e.g., a variable seam relative to the sensor data to be combined). For example, the computing system can compare distances associated with the first portion of the sensor data and the second portion of the sensor data to identify a distance associated with the first portion of the sensor data and the second portion of the sensor data (and associated with a particular location) that is greater than all or a portion of the other distances associated with the first portion of the sensor data and the second portion of the sensor data. The computing system may dynamically place the seam at the particular location and may combine the first portion of the sensor data and the second portion of the sensor data according to the placed seam.

In some cases, the computing system can utilize a fixed seam (e.g., a fixed seam relative to the sensor data to be combined). For example, the computing system can compare distances associated with the first portion of the sensor data and the second portion of the sensor data to identify a distance associated with the first portion of the sensor data and the second portion of the sensor data (and associated with a particular location) that is greater than all or a portion of the other distances associated with the first portion of the sensor data and the second portion of the sensor data. The computing system may dynamically instruct movement of the robot (or the sensor) such that the seam is placed at the particular location and may combine the first portion of the sensor data and the second portion of the sensor data according to the placed seam.

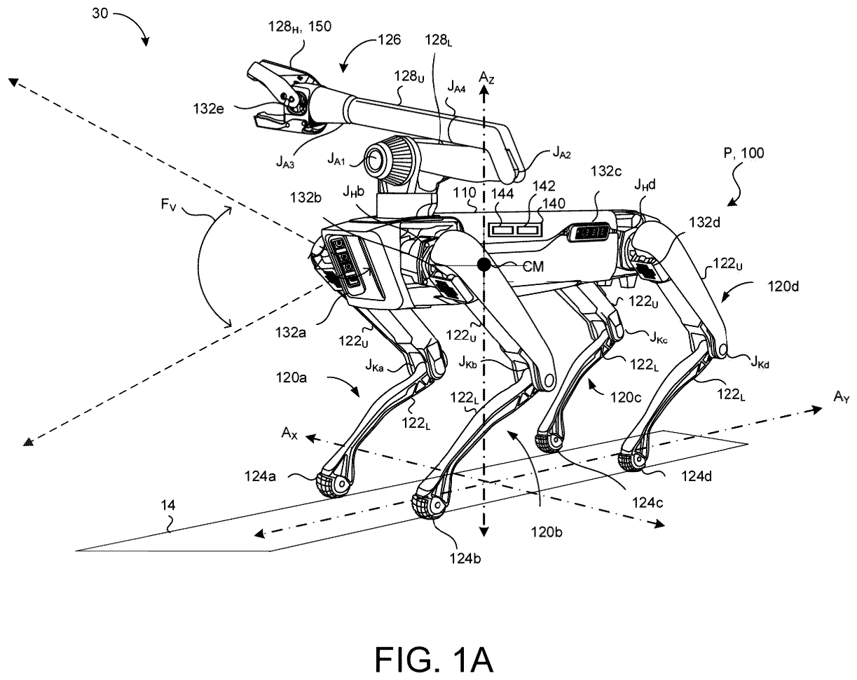

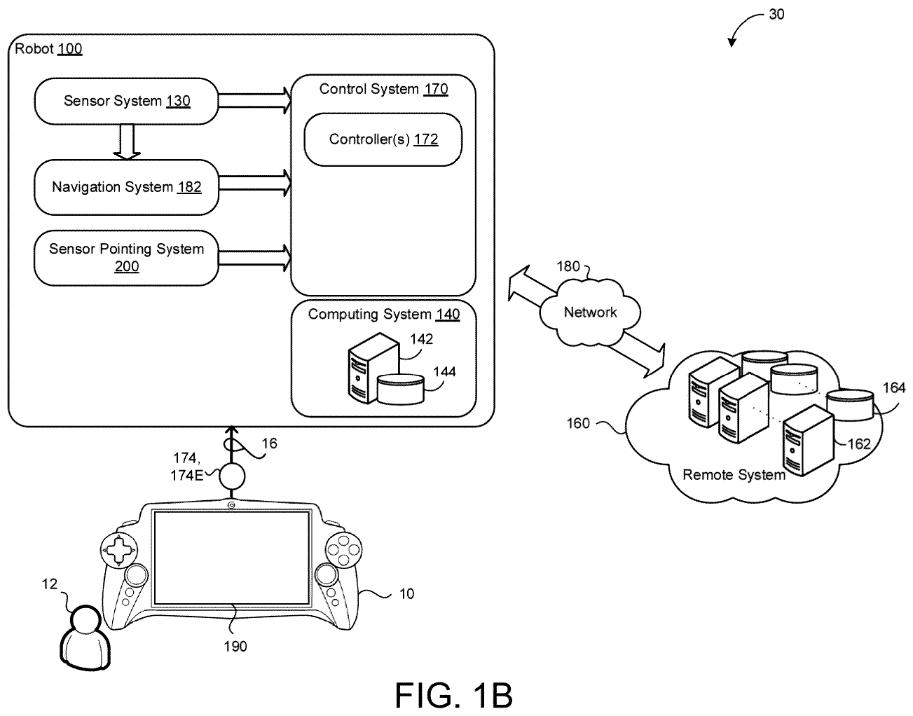

Referring to FIGS. 1A and 1B, in some implementations, a robot 100 includes a body 110 with one or more locomotion based structures such as a front right leg 120a, a front left leg 120b, a rear right leg 120c, and a rear left leg 120d coupled to the body 110 and that enable the robot 100 to move within the environment 30. In some examples, each leg is an articulable structure such that one or more joints J permit members of the leg to move. For instance, each leg includes a hip joint JH (for example, J_{H}b and J_{H}d of FIG. 1A) coupling an upper member 122_{U} of the leg to the body 110 and a knee joint JK (for example, Jₖₐ, J_{Kb}, J_{Ke}, and J_{Kd} of FIG. 1A) coupling the upper member 122_{U} of the leg to a lower member 122_{L} of the leg. Although FIG. 1A depicts a quadruped robot with a front right leg 120a, a front left leg 120b, a rear right leg 120c, and a rear left leg 120d, the robot 100 may include any number of legs or locomotive based structures (e.g., a biped or humanoid robot with two legs, or other arrangements of one or more legs) that provide a means to traverse the terrain within the environment 30.

In order to traverse the terrain, each of the front right leg 120a, the front left leg 120b, the rear right leg 120c, and the rear left leg 120d has a distal end (for example, a distal end 124a of the front right leg 120a, a distal end 124b of the front left leg 120b, a distal end 124c of the rear right leg 120c, and a distal end 124d of the rear left leg 120d of FIG. 1A) that contacts a surface of the terrain (e.g., a traction surface). In other words, the distal end of each leg is the end of the leg used by the robot 100 to pivot, plant, or generally provide traction during movement of the robot 100. For example, the distal end of a leg corresponds to a foot of the robot 100. In some examples, though not shown, the distal end of the leg includes an ankle joint such that the distal end is articulable with respect to the lower member 122_{L} of the leg.

In the examples shown, the robot 100 includes an arm 126 that functions as a robotic manipulator. The arm 126 may be configured to move about multiple degrees of freedom in order to engage elements of the environment 30 (e.g., objects within the environment 30). In some examples, the arm 126 includes one or more members, where the members are coupled by joints J such that the arm 126 may pivot or rotate about the joint(s) J. For instance, with more than one member, the arm 126 may be configured to extend or to retract. To illustrate an example, FIG. 1A depicts the arm 126 with three members corresponding to a lower member 128_{L} an upper member 128t, and a hand member 128_{H} (e.g., also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is also coupled to the upper member 128_{U} at a second arm joint J_{A2}, while the upper member 128_{U} is coupled to the hand member 128_{H} at a third arm joint J_{A3}.

In some examples, such as in FIG. 1A, the hand member 128_{H} is a mechanical gripper that includes a moveable jaw and a fixed jaw configured to perform different types of grasping of elements within the environment 30. In the example shown, the hand member 128_{H} includes a fixed first jaw and a moveable second jaw that grasps objects by clamping the object between the jaws. The moveable jaw is configured to move relative to the fixed jaw to move between an open position for the gripper and a closed position for the gripper (e.g., closed around an object).

In some implementations, the arm 126 additionally includes a fourth joint J_{A4}. The fourth joint J_{A4} may be located near the coupling of the lower member 128_{L} to the upper member 128_{U} and functions to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is needed for operation.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the front right leg 120a, the front left leg 120b, the rear right leg 120, and the rear left leg 120d relative to the body 110 alters the pose P of the robot 100 (e.g., the combination of the position of the CM of the robot and the attitude or orientation of the robot 100). Here, a height generally refers to a distance along the z-direction (e.g., along the z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where a distal end 124a of the front right leg 120a, a distal end 124b of the front left leg 120b, a distal end 124c of the rear right leg 120c, and a distal end 124d of the rear left leg 120d of the robot 100 may generate traction to help the robot 100 move within the environment 30. Another anatomical plane of the robot 100 is the frontal plane that extends across the body 110 of the robot 100 (e.g., from a left side of the robot 100 with the front right leg 120a to a right side of the robot 100 with the front left leg 120b). The frontal plane spans the X-Z plane by extending in directions of the x-direction axis A_{X} and the z-direction axis A_{Z}.

In order to maneuver about the environment 30 or to perform tasks using the arm 126, the robot 100 includes a sensor system with one or more sensors. For example, FIG. 1A illustrates a first sensor 132a mounted at a front of the robot 100 (e.g., near a front portion of the robot 100 adjacent the front right leg 120a and the front left leg 120b), a second sensor 132b mounted near the hip of the front left leg 120b, a third sensor 132c corresponding to one of the sensors mounted on a side of the body 110 of the robot 100, a fourth sensor 132d mounted near the hip of the rear left leg 120d, and a fifth sensor 132e mounted at or near the hand member 128_{H} of the arm 126 of the robot 100. The sensors may include vision/image sensors, inertial sensors (e.g., an inertial measurement unit (IMU)), force sensors, and/or kinematic sensors. Some examples of sensors include a camera such as a stereo camera a visual red-green-blue (RGB) camera, or a thermal camera, a time-of-flight (TOF) sensor, a scanning light-detection and ranging (LIDAR) sensor, or a scanning laser-detection and ranging (LADAR) sensor. Other examples of sensors include microphones, radiation sensors, and chemical or gas sensors.

In some examples, the sensor has a corresponding field(s) of view F_{V} defining a sensing range or region corresponding to the sensor. For instance, FIG. 1A depicts a field of a view F_{V} for the robot 100. Each sensor may be pivotable and/or rotatable such that the sensor, for example, changes the field of view F_{V} about one or more axis (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With sensors placed about the robot 100, the sensor system may have a 360 degree view or a nearly 360 degree view (with respect to the X-Y or transverse plane) of the surroundings of the robot 100.

When surveying a field of view F_{V} with a sensor, the sensor system generates sensor data (e.g., image data) corresponding to the field of view Fr. The sensor system may generate the field of view F_{V} with a sensor mounted on or near the body 110 of the robot 100 (e.g., the first sensor 132a, the second sensor 132b, etc.). The sensor system may additionally and/or alternatively generate the field of view F_{V} with a sensor mounted at or near the hand member 128_{H} of the arm 126 (e.g., the fifth sensor 132e). The one or more sensors capture the sensor data that defines the three-dimensional point cloud for the area within the environment 30 of the robot 100. In some examples, the sensor data is image data that corresponds to a three-dimensional volumetric point cloud generated by a three-dimensional volumetric image sensor. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data, various systems of the robot 100 may use the sensor data to define a current state of the robot 100 (e.g., of the kinematics of the robot 100) and/or a current state of the environment 30 about the robot 100. In other words, the sensor system may communicate the sensor data from one or more sensors to any other system of the robot 100 in order to assist the functionality of that system.

In some implementations, the sensor system includes sensor(s) coupled to a joint J. Moreover, these sensors may couple to a motor M that operates a joint J of the robot 100 (e.g., the second sensor 132b, the third sensor 132c, the fourth sensor 132d, etc.). Here, these sensors generate joint dynamics in the form of joint-based sensor data. Joint dynamics collected as joint-based sensor data may include joint angles (e.g., an upper member 122r relative to a lower member 122_{L} or hand member 128_{H} relative to another member of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor measures joint position (or a position of member(s) coupled at a joint J) and systems of the robot 100 perform further processing to derive velocity and/or acceleration from the positional data. In other examples, a sensor is configured to measure velocity and/or acceleration directly.

As the sensor system gathers sensor data, a computing system 140 stores, processes, and/or to communicates the sensor data to various systems of the robot 100 (e.g., the control system 170, a sensor pointing system 200, a navigation system 182, and/or remote controller 10, etc.). In order to perform computing tasks related to the sensor data, the computing system 140 of the robot 100 (which is schematically depicted in FIG. 1A and can be implemented in any suitable location(s), including internal to the robot 100) includes data processing hardware 142 and memory hardware 144. The data processing hardware 142 may execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg).

Additionally or alternatively, the computing system 140 can utilize computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data or other processed data (e.g., data processing locally by the computing system 140) may be stored in the remote system 160 and may be accessible to the computing system 140. In additional examples, the computing system 140 is configured to utilize the remote data processing hardware 162 and the remote memory hardware 164 as extensions of the data processing hardware 142 and the memory hardware 144 such that resources of the computing system 140 reside on resources of the remote system 160.

In some implementations, as shown in FIG. 1B, the robot 100 includes a control system 170. The control system 170 may be configured to communicate with systems of the robot 100, such as the sensor system 130, the navigation system 182 (e.g., with navigation commands), and/or the sensor pointing system 200 (e.g., with body pose commands). The control system 170 may perform operations and other functions using the computing system 140. The control system 170 includes a controller 172 (e.g., at least one controller) that can control the robot 100. For example, the controller 172 (e.g., a programable controller) controls movement of the robot 100 to traverse about the environment 30 based on input or feedback from the systems of the robot 100 (e.g., the sensor system 130 and/or the control system 170). In additional examples, the controller 172 controls movement between poses and/or behaviors of the robot 100. The controller 172 may be responsible for controlling movement of the arm 126 of the robot 100 in order for the arm 126 to perform various tasks using the hand member 128_{H}. For instance, the controller 172 controls the hand member 128_{H} (e.g., a gripper) to manipulate an object or element in the environment 30. For example, the controller 172 actuates the movable jaw in a direction towards the fixed jaw to close the gripper. In other examples, the controller 172 actuates the movable jaw in a direction away from the fixed jaw to close the gripper.

The controller 172 may control the robot 100 by controlling movement about one or more joints J of the robot 100. In some configurations, the controller 172 is software or firmware with programming logic that controls at least one joint J and/or a motor M which operates, or is coupled to, a joint J. A software application (e.g., a software resource) may refer to computer software that causes a computing device to perform a task. In some examples, a software application may be referred to as an “application,” an “app,” or a “program.” For instance, the controller 172 controls an amount of force that is applied to a joint J (e.g., torque at a joint J). The number of joints J that the controller 172 controls may be scalable and/or customizable for a particular control purpose. The controller 172 may control a single joint J (e.g., control a torque at a single joint J), multiple joints J, or actuation of one or more members (e.g., actuation of the hand member 128_{H}) of the robot 100. By controlling one or more joints J, actuators or motors M, the controller 172 may coordinate movement for all different parts of the robot 100 (e.g., the body 110, one or more of the front right leg 120a, the front left leg 120b, the rear right leg 120, the rear left leg 120d, the arm 126). For example, to perform a behavior with some movements, the controller 172 may control movement of multiple parts of the robot 100 such as, for example, two legs, four legs, or two legs combined with the arm 126. In some examples, the controller 172 may be an object-based controller that is setup to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 is configured to display the image that corresponds to three-dimensional field of view F_{V} of the one or more sensors. The image displayed on the user interface 190 of the remote controller 10 is a two-dimensional image that corresponds to the three-dimensional point cloud of sensor data (e.g., field of view F_{V}) for the area within the environment 30 of the robot 100. That is, the image displayed on the user interface 190 may be a two-dimensional image representation that corresponds to the three-dimensional field of view F_{V} of the one or more sensors.

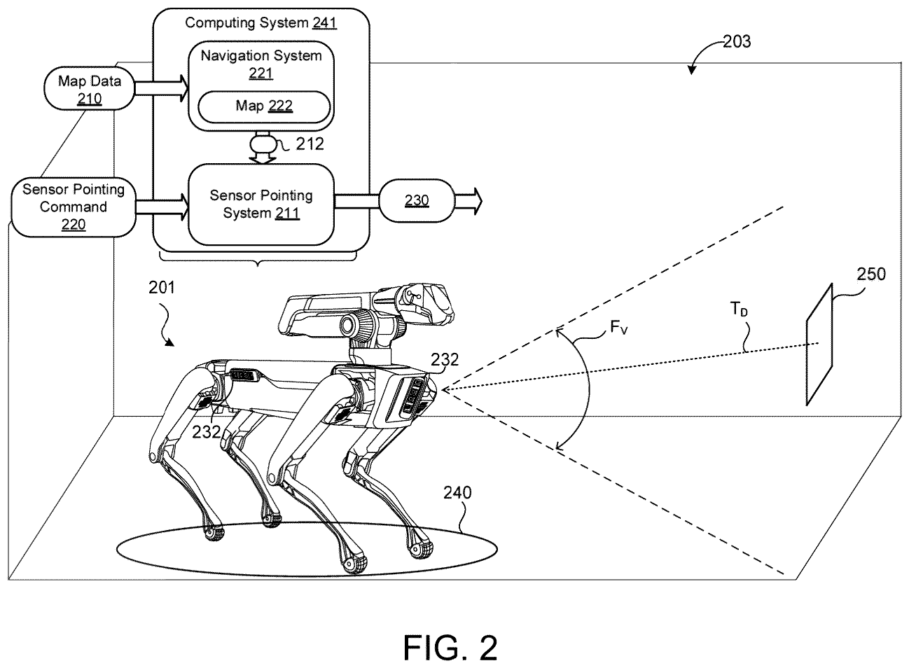

In some implementations, as shown in FIG. 2, the robot 201 (the robot 201 may include and/or may be similar to the robot 100 discussed herein with reference to FIG. 1A and FIG. 1B) is located in the environment 203 (the environment 203 may include and/or may be similar to the environment 30 discussed herein with reference to FIG. 1A and FIG. 1B) and is equipped with the sensor system that includes the sensor 232 (disposed on the body, in this example) on the robot 201 (the sensor 232 may include and/or may be similar to the first sensor 132a, the second sensor 132b, the third sensor 132c, the fourth sensor 132d, and/or the fifth sensor 132e discussed herein with reference to FIG. 1A) and having a field of view F_{V} that includes at least a portion of the environment 203.

The computing system 241 (the computing system 241 may include and/or may be similar to the computing system 140 discussed herein with reference to FIG. 1B) of the robot 201 is equipped with data processing hardware and memory hardware with the memory hardware including instructions to be executed by the data processing hardware. The computing system 241 may operate the navigation system 221 (the navigation system 221 may include and/or may be similar to the navigation system 182 discussed herein with reference to FIG. 1B) and the sensor pointing system 211 (for instance, in autonomous inspection applications) (the sensor pointing system 211 may include and/or may be similar to the sensor pointing system 200 discussed herein with reference to FIG. 1B) to navigate the robot 201 to a point of interest (“POI”) and uses a sensor 232 to capture sensor data at the POI in a particular way all without user input or supervision.

In the illustrated embodiment, the computing system 241 includes the navigation system 221 that generates or receives a map 222 (e.g., a navigation map, a graph map, etc.) from map data 210 obtained by the computing system 241. The navigation system 221 may generate a navigation route 212 (e.g., a route, a route path, etc.) that plots a path around large and/or static obstacles from a start location (e.g., the current location of the robot 100) to a destination. The navigation system 221 may be in communication with the sensor pointing system 211. The sensor pointing system 211 may receive the navigation route 212 or other data from the navigation system 221 in addition to sensor data from the sensor system.

The sensor pointing system 211 receives a sensor pointing command 220 (e.g., from a user) that directs the robot 201 to capture sensor data of a target location 250 (e.g., a specific area or a specific object in a specific area) and/or in a target direction T_{D}. The sensor pointing command 220 may include one or more of the target location 250, the target direction T_{D}, an identification of a sensor 232 (or multiple sensors) to capture sensor data with, etc. When the robot is proximate the target location, the sensor pointing system 211 generates one or more body pose commands 230 (e.g., to the control system) to position the sensor 232 such that the target location 250 and/or the target direction T_{D} are within the field of sensing of the sensor 232. For example, the sensor pointing system 211 determines necessary movements of the sensor 232 and/or of the robot 201 (e.g., adjust a position or orientation or pose P of the robot) to align the field of sensing of the sensor 232 with the target location 250 and/or target direction T_{D}.

In some examples, and as discussed in more detail below, the sensor pointing system 211 directs the pose P of the robot 201 to compensate for a sensed error in sensor 232 configuration or orientation. For example, the robot 201 may alter its current pose P to accommodate a limited range of motion of the field of view F_{V} of the sensor, avoid occluding the captured sensor data, or match a desired perspective of the target location 250. Thus, in some implementations, the sensor pointing system 211, based on an orientation of the sensor 232 relative to the target location 250, determines the target direction T_{D} to point the sensor 232 toward the target location 250.

Alternatively or additionally, the sensor pointing system 211 determines an alignment pose P_{A} of the robot to cause the sensor 232 to point in the target direction T_{D} toward the target location 250. The sensor pointing system 211 may command the robot 201 to move to the alignment pose P_{A} to cause the sensor 232 to point in the target direction T_{D}. After the robot 201 moves to the alignment pose P_{A}, and with the sensor 232 pointing in the target direction T_{D} toward the target location 250, the sensor pointing system 211 may command the sensor 232 to capture sensor data of the target location 250 in the environment 203.

In other words, the computing system 241 is configured to receive the sensor pointing command 220 (e.g., from the user) that, when implemented, commands the robot 201 to capture sensor data using the sensor 232 (or multiple sensors) disposed on the robot 201. Based on the orientation of the sensor 232 relative to the target location 250, the sensor pointing system 211 determines the target direction T_{D} and the alignment pose P of the robot 201. The determined target direction T_{D} points the sensor 232 toward the target location 250 and the determined alignment pose P_{A} of the robot 201 causes the sensor 232 to point in the target direction T_{D} toward the target location 250. The sensor pointing system 211 may command the robot 201 to move from a current pose P of the robot 201 to the alignment pose P_{A} of the robot 201. After the robot 201 moves to the alignment pose P_{A} and with the sensor 232 pointing in the target direction T_{D} toward the target location 250, the sensor pointing system 211 commands the sensor 232 to capture sensor data of the target location 250 in the environment 203.

As will become apparent from this disclosure, the sensor pointing system 211, along with other features and elements of the methods and systems disclosed herein, make the data capture of target locations 250 in environments 203 repeatable and accurate as the robot 201 is sensitive to sensed and unsensed error in the robot's position, orientation, and sensor configuration. The sensor pointing system 211 allows the robot 201 to overcome odometry and sensor error when capturing sensor data relative to the target location 250 at least in part by determining the target direction T_{D} for pointing the sensor 232 at the target location 250 and the alignment pose P_{A} for achieving the target direction T_{D} based on the orientation of the sensor 232 relative to the target location 250.

In some examples, in response to receiving the sensor pointing command 220, the sensor pointing system 211 commands the robot 201 to navigate to a target POI 240 within the environment 203. In such examples, the sensor pointing system 211 determines the target direction T_{D} and the alignment pose P_{A} of the robot 201 after the robot 201 navigates to the target POI 240.

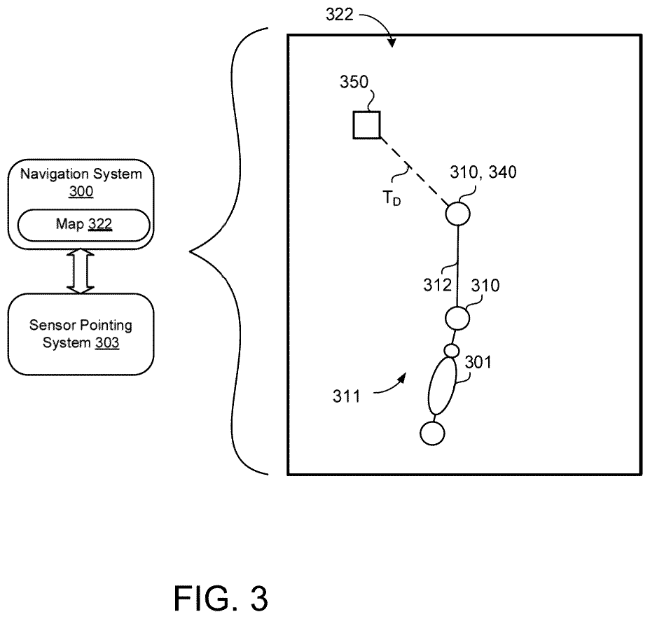

Referring now to FIG. 3, in some examples, the navigation system 300 (e.g., based on map data, sensor data, etc.) (the navigation system 300 may include and/or may be similar to the navigation system 182 discussed herein with reference to FIG. 1B) generates a series of route waypoints 310 on the map 322 (the map 322 may include and/or may be similar to the map 222 discussed herein with reference to FIG. 2) for the navigation route 311 (the navigation route 311 may include and/or may be similar to the navigation route 212 discussed herein with reference to FIG. 2) that plots a path around large and/or static obstacles from a start location (e.g., the current location of the robot 301 which may be similar and/or may include the robot 100 discussed herein with reference to FIG. 1A and FIG. 1B) to a destination (e.g., the target POI 340 which may be similar and/or may include the target POI 240 discussed herein with reference to FIG. 2). Route edges 312 connect corresponding pairs of adjacent route waypoints. The robot 301, when navigating the environment, travels from route waypoint to route waypoint by traversing along the route edges 312. In some examples, the target POI 340 is a route waypoint on the map 322. In the example shown, the robot 301 travels along the navigation route 311 until reaching the target POI 340 (e.g., a specified route waypoint). In some examples, the target POI 340 is the final route waypoint along the navigation route 311, while in other examples, the navigation route 311 continues on with additional route waypoints and route edges 320 for the robot 301 to continue along after capturing the sensor data at the target POI 340 and the navigation route 311 may include any number of target POIs for capturing sensor data at various locations along the navigation route 311.

Thus, based on guidance provided by the navigation system 300, the robot 301 arrives at a route waypoint defined by the target POI 340. After arrival at the waypoint, the sensor pointing system 303 (the sensor pointing system 303 may include and/or may be similar to the sensor pointing system 200 discussed herein with reference to FIG. 1B) may determine an orientation of the sensor relative to the target location 350 (the target location 350 may include and/or may be similar to the target location 250 discussed herein with reference to FIG. 2). Based on the orientation of the sensor relative to the target location 350, the sensor pointing system 303 determines the target direction T_{D} for pointing the sensor toward the target location 350.

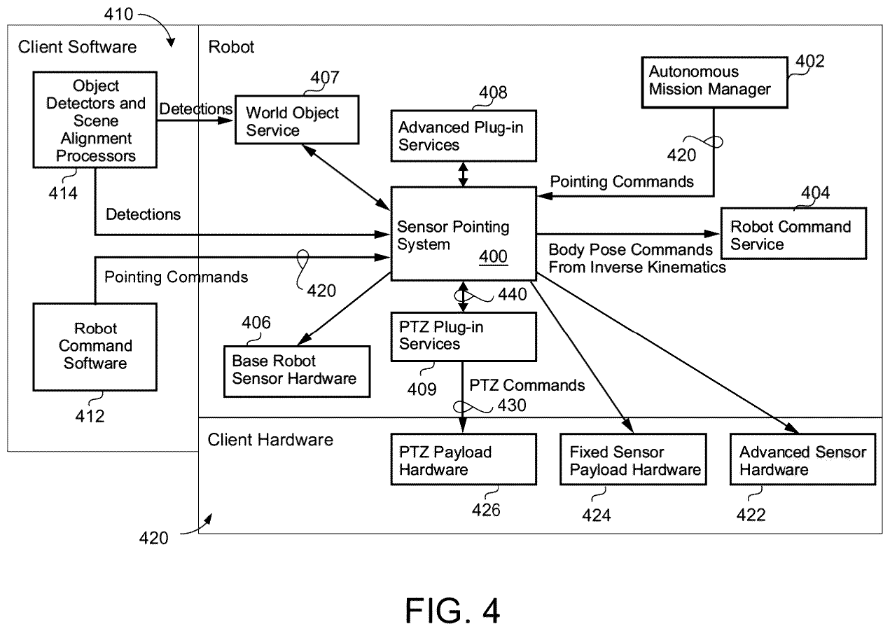

Although examples herein (e.g., FIG. 2) illustrate the sensor integrated into the body of the robot 301 at a front portion of the robot 301 with a field of view F_{V} primarily forward of the robot, the sensor (or sensors) may be disposed in any suitable manner on the robot 301. The sensor may include any number of different types of sensors such as a camera, LIDAR, and/or microphone. For example, the sensor may be built into the body of the robot 301 or attached as a payload. In some examples, the sensor is disposed on the articulated arm of the robot 301. Additionally, the sensor may be permanently fixed to the robot 301 as part of its original manufacture or alternatively disposed or mounted at the robot 301 (e.g., client hardware) and connected to the sensor pointing system 303 via client software (FIG. 4). The sensor may have any fixed or pivotable (e.g., a pan-tilt-zoom (PTZ) sensor such as a PTZ camera) field of view/field of sensing. Because the orientation of the sensor is based at least in part on the pose P of the robot 301, movement of the robot 301, such as to the alignment pose P_{A}, changes the field of view of the sensor.

The target direction T_{D}, in some examples, is parameterized by the sensor pointing command. In other words, the sensor pointing command may include instructions as to how the sensor data of the target location 350 should be captured, such as from a certain direction, angle, zoom, focus, and/or distance relative to the target location 350 or with the target location 350 framed a certain way in the field of view F_{V} of the sensor. Thus, the sensor pointing command may include parameters for capturing sensor data of the target location 350, such as angle, height, proximity, and direction of the sensor relative to the target location, and parameters related to placement of the target location 350 within the captured sensor dat. The parameters may also include configuration for the sensor while capturing the sensor data (e.g., zoom, focus, exposure, control of illumination sources, etc.). The sensor pointing system 303 may determine the target direction T_{D} based on the parameters of the sensor pointing command. Alternatively, the target direction T_{D} may be provided by the sensor pointing command. Based on the parameters of the sensor pointing command and/or the target direction T_{D}, the sensor pointing system 303 commands the robot 301 (e.g., to the alignment pose P_{A}) and/or sensor to move to orient the sensor toward the target location 350.

Referring now to FIG. 4, the sensor pointing system 400 (the sensor pointing system 400 may include and/or may be similar to the sensor pointing system 200 discussed herein with reference to FIG. 2) may determine the target direction T_{D} and the alignment pose P_{A} in response to receiving the sensor pointing command 421 (the sensor pointing command 421 may include and/or may be similar to the sensor pointing command 220 discussed herein with reference to FIG. 2). The sensor pointing command 421 may originate from an autonomous mission manager 402 (e.g., generated from mission data or parameters, robot configuration, etc.) and/or from client software 410 that includes robot command software 412. Thus, a user computing device may communicate a sensor pointing command 421 to the robot (e.g., wirelessly via a controller) or a robot may generate the sensor pointing command 421 within the context of an autonomous mission. The sensor pointing system 400 may include a sensor pointing service. The sensor pointing command 421 may be communicated to the sensor pointing service (e.g., by the autonomous mission manager 402 or the robot command software 412) to determine the target direction T_{D} and sensor configurations for capturing the sensor data.

In some implementations, the client software 410 (in communication with the computing system of the robot) includes object detectors and scene alignment processors 414 that process the sensor data captured by the sensor. For example, the object detectors detect objects present in captured image data. In other implementations, the sensor pointing system 400 includes the object detectors and/or scene alignment processors and processes the sensor data automatically. The client software 410 may execute locally at the robot or may execute remote from the robot (e.g., at a controller, a remote system, or at any other server exterior the robot and in communication with the computing system of the robot).

The sensor pointing system 400 may also be in communication with the mechanical systems of the robot. For example, as shown in FIG. 4, the sensor pointing system 400 may communicate the body pose commands to a robot command service 404 of the computing system, and various sensors disposed at or in communication with the robot, such as base robot sensor hardware 406, advanced plug-in sensors 408, and client hardware 420. For example, the client hardware 420, includes advanced sensor hardware 422, fixed sensor hardware 424, and a PTZ payload hardware 426 at the robot. In certain implementations, the robot can be instructed to move in multiple command ways, including both map navigation and robot commands.

In some implementations, the PTZ payload hardware 426 (e.g., a sensor) communicates with PTZ plug-in services 409 which are operable to, for example, receive sensor data from the PTZ payload hardware 426 and communicate PTZ commands 430 to the PTZ payload hardware 426. The PTZ plug-in services 409 may be sensor specific (e.g., a hardware interface) and may execute client-side (e.g., external to the robot). In some examples, the PTZ plug-in services 409 execute within the sensor. In some implementations, the PTZ payload hardware 426 is a sensor (e.g., a PTZ camera) temporarily mounted to or connected with the robot. The sensor pointing system 400 may delegate reconfiguration of the PTZ payload hardware 426 to the PTZ plug-in services 409.

When the robot includes a PTZ sensor, and after the system obtains or determines the target direction T_{D} for pointing the PTZ sensor toward the target location, the sensor pointing system 400 may sense or detect and correct any existing error (e.g., discrepancy) between the current direction of the PTZ sensor (e.g., a vector along the center of the field of sensing of the PTZ sensor) and the target direction T_{D}. The center of the field of sensing refers to a vector that originates at the PTZ sensor and extends away from the PTZ sensor such that the sensor's field of sensing to the left and to the right of the vector are of equivalent size and the sensor's field of sensing above and below the vector are of equivalent size.

In such implementations, the sensor pointing system 400 determines whether the center of a field of sensing of the PTZ sensor (or other sensor) is aligned with the target direction T_{D} and, if the center of field of sensing, (e.g., the “aim”) of the PTZ sensor is not aligned with the target direction T_{D}, the sensor pointing system 400 determines PTZ alignment parameters for aligning the center of the field of sensing of the PTZ sensor with the target direction T_{D}. Furthermore, the sensor pointing system 400 may command the PTZ sensor, e.g., using the PTZ alignment parameters, to adjust the center of the field of sensing of the PTZ sensor (e.g., commanding the PTZ sensor to pan, tilt, and/or zoom) to align with the target direction T_{D}. Thus, the target direction T_{D} may be parameterized, at least in part, by PTZ alignment parameters.

In some implementations, after commanding the PTZ sensor to adjust the center of the field of sensing of the PTZ sensor, the sensor pointing system 400 receives, from the PTZ sensor (e.g., via the PTZ plug-in services 409), alignment feedback data 440. The alignment feedback data 440 indicates the current PTZ parameters of the PTZ sensor. That is, the alignment feedback data 440 indicates the current orientation of the PTZ sensor relative to the pose P of the robot. In some examples, the sensor pointing system 400 determines a difference, based on the alignment feedback data 440, between the current alignment of the center of the field of sensing of the PTZ sensor and the target direction T_{D}. When there is a difference (e.g., above a threshold difference), the sensor pointing system 400 determines, based on the difference between the current alignment of the center of the field of sensing of the PTZ sensor and the target direction T_{D}, the alignment pose P_{A} that will correct the difference between the pointing direction of the PTZ sensor and the target direction T_{D}. Thus, in these examples, determining the alignment pose P_{A} of the robot is based on the alignment feedback data 440 from the PTZ sensor. In other examples, such as when the sensor is fixed, alignment of the sensor relies entirely on the alignment post P_{A} of the robot.

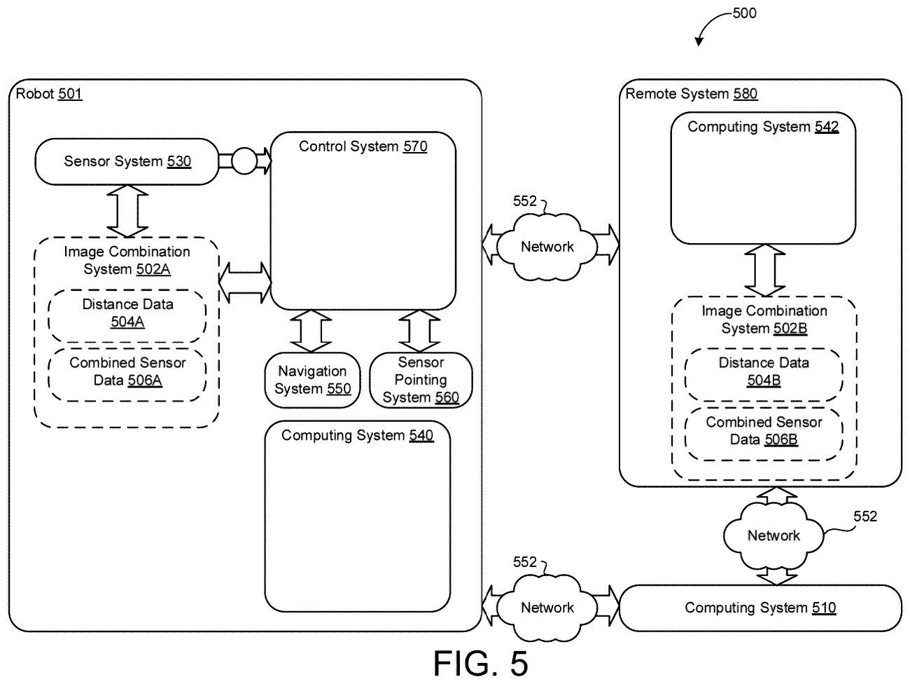

Referring now to FIG. 5, an environment 500 may include a robot 501 (the robot 501 may include and/or may be similar to the robot 100 discussed herein with reference to FIG. 1A and FIG. 1B), a remote system 580 (the remote system 580 may include and/or may be similar to the remote system 160 discussed herein with reference to FIG. 1B), and a computing system 510 (the computing system 510 may include and/or may be similar to the remote controller 10 discussed herein with reference to FIG. 1B). The robot 501, the computing system 510 (e.g., a user computing device), and the remote system 580 may each be in communication (e.g., via the network 552 which may include and/or may be similar to the network 180 discussed herein with reference to FIG. 1B) with one another (e.g., the robot 501 may be in communication with the remote system 580). In some cases, the robot 501 may be in communication with multiple computing systems. For example, the robot 501 may be in communication with a plurality of user computing devices associated with a plurality of users. In some cases, a plurality of robots may be in communication with the computing system 510 and/or the remote system 580.

As discussed herein with reference to FIG. 1B, the robot 501 may include a sensor system 530, a computing system 540, a navigation system 550, a sensor pointing system 560, and a control system 570. For example, where the environment 500 includes a plurality of robots, all or a portion of the plurality of robots may include a respective sensor system, a respective control system, and/or a respective computing system.

The sensor system 530 can gather sensor data. The sensor system 530 may include a plurality of sensors (e.g., image sensors) of the robot 501 and the sensor system 530 may gather the sensor data via the plurality of sensors. The sensor system 530 may include and/or may be similar to the sensor system 130 discussed herein with reference to FIG. 1B. The sensor system 530 may provide the sensor data to other systems of the robot 501 (e.g., the control system 570).

In one example, the sensor system 530 may include a plurality of sensors (e.g., five sensors) distributed on the robot 501. For example, the sensor system 530 may include a plurality of sensors distributed across the body, one or more legs, arm, etc. of the robot 501. The plurality of sensors may include at least two different types of sensors. For example, the plurality of sensors may include lidar sensors, image sensors (e.g., stereo realsense cameras), ladar sensors, audio sensors, etc. and the sensor data may include lidar sensor data, image (e.g., camera) sensor data, ladar sensor data, audio data, etc.

In some cases, sensors of the sensor system 530 may be attached to the robot 501 using different manners of attachment. For example, the sensor system 530 may include one or more first sensors that are integrated within the body of the robot 501 and one or more second sensors that are attached to the body of the robot 501 (e.g., removable sensors).

Sensors of the sensor system 530 may have different poses, orientations, rotations, translations, etc. For example, a first sensor of the sensor system 530 may be located on the robot 501 at a first location and a second sensor of the sensor system 530 may be located on the robot 501 at a second location that is separated by 20 centimeters or a different length from the first location. In another example, a first sensor of the sensor system 530 may be oriented (e.g., facing a direction) parallel to a ground surface of the robot 501 and a second sensor of the sensor system 530 may be oriented towards the ground surface of the robot 501. In another example, sensors of the sensor system 530 may be positioned using the sensor pointing system 560 as discussed herein,

In some cases, the sensor data may include three-dimensional point cloud data. The sensor system 530 (or a separate system) may use the three-dimensional point cloud data to detect and track features within a three-dimensional coordinate system. For example, the sensor system 530 may use the three-dimensional point cloud data to detect and track movers within the environment.

The computing system 540 may include data processing hardware (e.g., a data processor, a hardware processor, etc.) and memory hardware. The memory hardware may store instructions and the data processing hardware may execute the instructions which may cause the data processing hardware to perform one or more operations. The computing system 540 may include and/or may be similar to the computing system 140 discussed herein with reference to FIG. 1B.

The control system 570 may include a controller (e.g., similar to the controller 172 discussed herein). The control system 570 may include and/or may be similar to the control system 170 discussed herein with reference to FIG. 1B.

The sensor pointing system 560 may include and/or may be similar to the sensor pointing system 200 discussed herein with reference to FIG. 1B. The navigation system 550 may include and/or may be similar to the navigation system 182 discussed herein with reference to FIG. 1B.

The remote system 580 may include a computing system 542. The computing system 542 may include data processing hardware and/or memory hardware.

The robot 501 and/or the remote system 580 may further include a respective image combination system. For example, as shown in FIG. 5, the robot 501 includes an image combination system 502A and the remote system 580 includes an image combination system 502B. In some cases, one or more of the robot 501 or the remote system 580 may not include an image combination system. For example, the robot 501 may include the image combination system 502A and the remote system 580 may not include the image combination system 502B.

In the example of FIG. 5, the image combination system 502A includes distance data 504A and combined sensor data 506A. Further, the image combination system 502B includes distance data 504B and combined sensor data 506B. The image combination system 502A and the image combination system 502B may utilize the distance data 504A and 504B to generate combined sensor data 506A and 506B from sensor data (e.g., sensor data obtained from the sensor system 530).

The image combination systems 502A and 502B may obtain an input (e.g., instructing generation of the combined sensor data 506A and 506B). For example, the image combination systems 502A and 502B may obtain an input from the computing system 510 and the input may instruct generation of a panoramic representation of an environment. Further, the input may indicate a particular location or portion of the environment of the robot 501 for the panoramic representation, one or more particular sensors from which to obtain the sensor data for generation of the panoramic representation, etc. In some cases, the image combination systems 502A and 502B may not obtain an input and may generate the combined sensor data 506A and 506B (e.g., continuously).

The image combination systems 502A and 502B may obtain sensor data for combination (e.g., in response to the input). In some cases, the image combination systems 502A and 502B may obtain (e.g., in real time) the sensor data directly from the sensor system 530 (e.g., the sensor system 530 may stream the sensor data to the sensor system 530). In some cases, the sensor system 530 may store the sensor data in memory (e.g., in a bucket) and the image combination systems 502A and 502B may obtain the sensor data from memory.

The sensor data may include first sensor data (e.g., first image data) and second sensor data (e.g., second image data). The image combination systems 502A and 502B may identify the second sensor data for combination (e.g., a first image and a second image of the second sensor data for combination) using distance data 504A and 504B determined based on the first sensor data and/or the second sensor data. The image combination systems 502A and 502B may obtain the first sensor data from one or more first sensors of the sensor system 530 and may obtain the second sensor data from one or more second sensors of the sensor system 530.

In some cases, the image combination systems 502A and 502B may obtain one or more maps (e.g., a voxel map, a depth map, a spherical depth map, etc.) based on the first sensor data and the second sensor data. For example, the one or more maps may indicate one or more distances associated with an environment of the robot 501 based on the sensor data (e.g., a distance from a sensor of the robot 501, a body of the robot 501, an appendage of the robot 501, etc. to an obstacle, object, entity, and/or structure in the environment). Further, the one or more maps may include a plurality of cells and all or a portion of the plurality of cells may indicate a respective distance.

The one or more maps may include one or more first maps based on the first sensor data and one or more second maps based on the second sensor data. The one or more first maps and the one or more second maps may be generated according to different mapping criteria or mapping algorithms, may be generated by different systems, etc.

To generate the one or more first maps, the robot 501 may include and may implement a perception system that generates the one or more first maps. The perception system may generate the one or more first maps (e.g., representing a three-dimensional environment of the robot 501) based on the first sensor data. In another example, the navigation system 550 may generate the one or more first maps.

To generate the one or more second maps, the robot 501 may provide the second sensor data to a machine learning model (e.g., to a computing system implementing the machine learning model). For example, the robot 501, the remote system 580, the computing system 510, or a separate system may implement the machine learning model (e.g., a monocular depth network). Based on providing the second sensor data to the machine learning model, the robot 501 may obtain the one or more second maps.

In some cases, the robot 501 may not obtain the second sensor data and/or may not generate the one or more second maps. Instead, the robot 501 may obtain the one or more second maps from a computing system implementing the machine learning model using the second sensor data.

The image combination systems 502A and 502B may identify distance data 504A and 504B (e.g., indicative of one or more distances) associated with the sensor data. For example, the image combination systems 502A and 502B may identify distance data 504A and 504B associated with the first sensor data (e.g., the one or more first maps) and/or the second sensor data (e.g., the one or more second maps). In some cases, the image combination systems 502A and 502B may identify a first portion of the distance data 504A and 504B associated with the first sensor data and a second portion of the distance data 504A and 504B associated with the second sensor data. In some cases, the image combination systems 502A and 502B may not identify distance data 504A and 504B associated with the first sensor data or the second sensor data.

In some cases, to identify the distance data 504A and 504B, the image combination systems 502A and 502B may process the one or more first maps and/or the one or more second maps. For example, the image combination systems 502A and 502B may identify an object, entity, obstacle, and/or structure in the one or more first maps and determine a distance to the object, entity, obstacle, and/or structure as indicated by the one or more first maps. In another example, the image combination systems 502A and 502B may identify an object, entity, obstacle, and/or structure in the one or more first maps, determine a first distance to the object, entity, obstacle, and/or structure as indicated by the one or more first maps, identify the same object, entity, obstacle, and/or structure in the one or more second maps, determine a second distance to the object, entity, obstacle, and/or structure as indicated by the one or more second maps, and determine the distance data 504A and 504B based on the first distance and the second distance (e.g., by averaging the first distance and the second distance).

In some cases, to identify the distance data 504A and 504B, the image combination systems 502A and 502B may provide the first sensor data (e.g., the one or more first maps) and/or the second sensor data (e.g., the one or more second maps) to a machine learning model (e.g., a machine learning model implemented by the robot 501 or by a separate system). The machine learning model may be trained to output a distance based on input sensor data (e.g., input maps). For example, the machine learning model may perform a monocular depth estimation and output a distance based on the monocular depth estimation. In another example, the distance may be a monocular depth estimation. The image combination systems 502A and 502B may obtain the distance data 504A and 504B (e.g., the distance) from the machine learning model.

In some cases, to identify the distance data 504A and 504B, the image combination systems 502A and 502B may use the first sensor data (e.g., the one or more first maps) to determine a scale (e.g., 1:50, 1:100, etc.). For example, the image combination systems 502A and 502B may compare a measurement between two feature points within the first sensor data and a measurement between portions of the environment corresponding to the two features to determine the scale. The image combination systems 502A and 502B may identify a distance using the second sensor data (e.g., the one or more second maps) and may adjust (e.g., scale) the distance using the determined scale to identify the distance data 504A and 504B.

In some cases, the image combination systems 502A and 502B may identify the distance data 504A and 504B based on or in response to the input (e.g., instructing the generation of the combined sensor data 506A and 506B). For example, the image combination systems 502A and 502B may receive the input and, in response to the input, obtain sensor data and determine the distance data 504A and 504B based on the sensor data.

The image combination systems 502A and 502B may identify all or a portion of the sensor data for combination. For example, the image combination systems 502A and 502B may identify a first portion of the second sensor data (e.g., a first image) for combination with a second portion of the second sensor data (e.g., a second image) based on the input. In some cases, the image combination systems 502A and 502B may combine the first sensor data (e.g., used to generate the one or more second maps), the second sensor data (e.g., used to generate the one or more second maps), at least a portion of the first sensor data and/or the second sensor data, additional sensor data from the one or more first sensors and/or the one or more second sensors, and/or sensor data from one or more third sensors of the robot 501. In some cases, the image combination systems 502A and 502B may adjust sensor data for combination based on the distance data 504A and 504B. For example, the image combination systems 502A and 502B may adjust one or more distances associated with the sensor data for combination based on the distance data 504A and 504B.

The image combination systems 502A and 502B can combine sensor data (e.g., a first image and a second image of the second sensor data) to obtain the combined sensor data 506A and 506B. The image combination systems 502A and 502B may combine the sensor data according to a seam (e.g., a seam between the first image and the second image). In some cases, as discussed herein, the image combination systems 502A and 502B may use the distance data 504A and 504B to place the seam (e.g., by instructing movement of the robot or the sensor and/or by virtually moving the seam within the combined sensor data 506A and 506B). For example, the image combination systems 502A and 502B may use the distance data 504A and 504B to place the seam at a location within the sensor data that corresponds to a portion of the environment (e.g., an obstacle, entity, object, and/or structure) that is further away from a portion of the robot 501 (e.g., a sensor of the robot 501) as compared to other locations within the sensor data. In another example, the image combination systems 502A and 502B may route instructions to the sensor pointing system 560 to position the sensor such that the seam is placed at a location as discussed herein.

The image combination systems 502A and 502B may use the distance data 504A and 504B to identify artifacts within the combined sensor data 506A and 506B. For example, the image combination systems 502A and 502B may use the distance data 504A and 504B to classify portions of the combined sensor data 506A and 506B as artifacts or non-artifacts (e.g., based on placement of a seam). The image combination systems 502A and 502B may adjust the combined sensor data 506A and 506B (e.g., displayed via a computing device such that the seam is indicated). For example, the image combination systems 502A and 502B may determine that the combined sensor data 506A and 506B may include artifacts (e.g., based on the distance) and may adjust (e.g., flag) a portion of the combined sensor data 506A and 506B including the artifacts (e.g., to reduce parallax) from the combined sensor data 506A and 506B (e.g., such that the portion of the combined sensor data 506A and 506B is not displayed). In some cases, based on classifying particular portions of the combined sensor data 506A and 506B as artifacts, the image combination systems 502A and 502B may generate an alert and route the alert to a computing system (e.g., the computing system 510) and/or may flag particular sensor data. For example, the image combination systems 502A and 502B may determine that the combined sensor data 506A and 506B may include artifacts (e.g., based on the distance) and may generate an alert indicating that the combined sensor data 506A and 506B includes artifacts and requesting review of the artifacts, flagging of the artifacts, removal of the artifacts, authorization to remove the artifacts, etc.

In some cases, based on combining the sensor data, the image combination systems 502A and 502B may instruct display of the combined sensor data 506A and 506B. For example, the image combination systems 502A and 502B may instruct display of the combined sensor data 506A and 506B (e.g., a video stream) via a user interface of a computing system (e.g., the computing system 510). In some cases, the image combination systems 502A and 502B may stream the combined sensor data 506A and 506B to the computing system.

The image combination systems 502A and 502B may obtain feedback from the computing system. For example, the feedback may include input identifying whether an identified artifact corresponds to an artifact. In another example, the feedback may include input identifying one or more artifacts within the combined sensor data 506A and 506B (e.g., artifacts that may or may not have been identified by the image combination systems 502A and 502B).

In some cases, the image combination systems 502A and 502B may retrain a machine learning model for identifying the distance data 504A and 504B based on the feedback. In some cases, the computing system may trigger retraining of the machine learning model and the image combination systems 502A and 502B may obtain the retrained machine learning model from the user computing device.

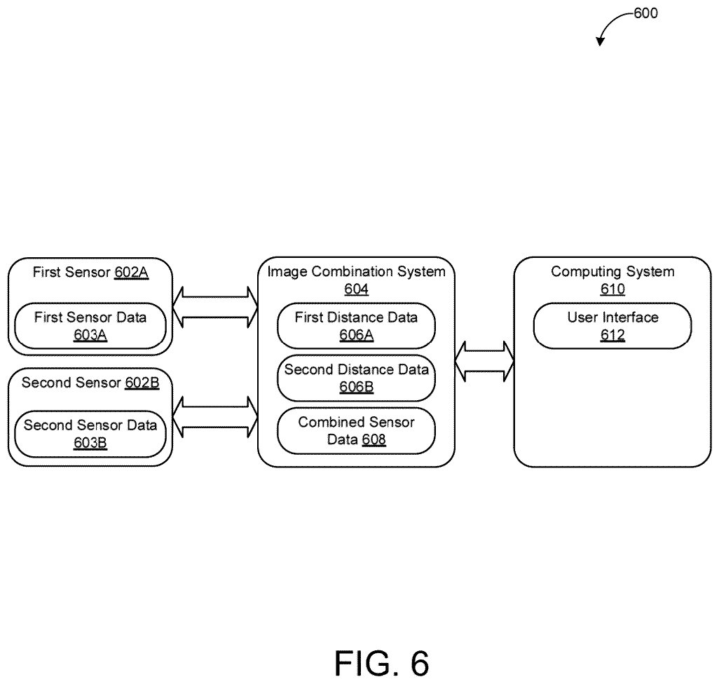

Referring now to FIG. 6, a robot 600 (which may include and/or may be similar to the robot 100 as discussed herein with reference to FIG. 1A and FIG. 1B) may include a first sensor 602A, a second sensor 602B, an image combination system 604 (which may include and/or may similar to the image combination systems 502A and 502B as discussed herein with reference to FIG. 5), and a computing system 610 (which may include and/or may be similar to the computing system 140 discussed herein with reference to FIG. 1B).

In some cases, the first sensor 602A and the second sensor 602B may not be aligned (e.g., the first sensor 602A and the second sensor 602B may have different poses, orientations, rotations, translations, etc.). For example, the first sensor 602A and the second sensor 602B may have a different pose, a different orientation, and a different translation (e.g., 0.25 meter translation between the first sensor 602A and the second sensor 602B).

In some cases, the first sensor 602A and the second sensor 602B may correspond to the same sensor. For example, the first sensor 602A may correspond to a sensor having a first pose, orientation, rotation, translation, etc. and the second sensor 602B may correspond to the same sensor having a second pose, orientation, rotation, translation, etc. (e.g., based on movement of the sensor using a sensor pointing system). In another example, the first sensor 602A may correspond to a sensor during a first time period and the second sensor 602B may correspond to the same sensor during a second time period.

The first sensor 602A may obtain first sensor data 603A. For example, the first sensor data 603A may include first image data obtained via the first sensor 602A. The first sensor 602 may route the first sensor data 603A to the image combination system 604. In some cases, the first sensor 602 may route the first sensor data 603A to memory that is accessible by the image combination system 604.

In some cases, as discussed herein, the first sensor 602A may route the first sensor data 603A to a system of the robot 600 (e.g., a perception system of the robot 600) and the system may generate one or more first maps based on the first sensor data 603A. For example, a perception system may generate a voxel map based on the first sensor data 603A. The image combination system 604 may obtain the one or more first maps (e.g., from the perception system).

The second sensor 602B may obtain second sensor data 603B. For example, the second sensor data 603B may include second image data obtained via the second sensor 602B. The second sensor 602B may route the second sensor data 603B to the image combination system 604. In some cases, the second sensor 602B may route the second sensor data 603B to memory that is accessible by the image combination system 604.

In some cases, as discussed herein, the second sensor 602B may route the second sensor data 603B to a system (e.g., a system separate from the robot) and the system may generate one or more second maps based on the second sensor data 603B. For example, the second sensor 602B may route the second sensor data 603B to a system implementing a machine learning model. The system may provide the second sensor data 603B to the machine learning model as an input and may obtain one or more second maps as an output of the machine learning model. The image combination system 604 may obtain the one or more second maps (e.g., from the system).

In some cases, the one or more first maps may be a more accurate representation of the environment as compared to the one or more second maps. For example, the one or more first maps may identify a more accurate distance to a portion of the environment, may more accurately represent objects, entities, structures, and/or obstacles within the environment, etc. as compared to the one or more second maps. In some cases, the one or more second maps may correspond to a larger field of view of the environment as compared to the one or more first maps. For example, a field of view associated with the one or more first maps may be a subset of a field of view associated with the one or more second maps.

The image combination system 604 may obtain the first sensor data 603A and the second sensor data 603B as discussed herein. The image combination system 604 may determine first distance data 606A based on the first sensor data 603A and may determine second distance data 606B based on the second sensor data 603B. For example, the image combination system 604 may process the first sensor data 603A to determine first distance data 606A indicating a distance between a portion of the environment and a portion of the robot 600 and may process the second sensor data 603B to determine second distance data 606B indicating a distance between a portion of the environment (e.g., a same portion of the environment) and a portion of the robot 600 (e.g., the same portion of the robot 600).

In some cases, the image combination system 604 may combine all or a portion of the first sensor data 603A and/or all or portion of the second sensor data 603B. The image combination system 604 may determine the first distance data 606A based on the combined first sensor data and/or may determine the second distance data 606B based on the combined second sensor data.

In some cases, the image combination system 604 may obtain the one or more first maps and/or the one or more second maps. The image combination system 604 may determine the first distance data 606A based on the one or more first maps and may determine the second distance data 606B based on the one or more second maps.

In some cases, the image combination system 604 may determine third distance data based on the first distance data 606A and the second distance data 606B. For example, the first distance data 606A may include a scale and the image combination system 604 may adjust a distance of the second distance data 606B using the scale. In another example, the image combination system 604 may determine a scale based on the first distance data 606A and may adjust a distance of the second distance data 606B using the scale.

In some cases, to determine the third distance data, the image combination system 604 may provide the first sensor data 603A and/or the second sensor data 603B to a machine learning model and may receive the third distance data as an output of the machine learning model. In some cases, to determine the third distance data, the image combination system 603 may provide the one or more first maps and/or the one or more second maps to a machine learning model and may receive the third distance data as an output of the machine learning model. In some cases, to determine the third distance data, the image combination system 603 may provide the first distance data 606A and the second distance data 606B to a machine learning model and may receive the third distance data as an output of the machine learning model.

In some cases, the first distance data 606A may indicate a respective distance for all or a portion of the pixels of the first sensor data 603A, the second distance data 606B may indicate a respective distance for all or a portion of the pixels of the second sensor data 603B and/or combined sensor data 608, and/or the third distance data may indicate a respective distance for all or a portion of the pixels of the combined sensor data 608.

As discussed herein, the image combination system 604 may generate combined sensor data 608 based on the first sensor data 603A and/or the second sensor data 603B. For example, the image combination system 604 may identify five images of the second sensor data 603B. The image combination system 604 may stitch the five images together to obtain the combined sensor data 608 (e.g., a panoramic representation of the environment).

In some cases, the image combination system 604 may generate combined sensor data 608 based on third data. For example, the image combination system 604 may obtain third data from the first sensor 602A, the second sensor 602B, or a third sensor and may combine the third data to generate the combined sensor data 608. In some cases, the combined sensor data 608 may be a panoramic representation of the environment (e.g., an equirectangular panoramic representation of the environment).

In some cases, the image combination system 604 may combine the first sensor data 603A, the second sensor data 603B, and/or the third sensor data to generate the combined sensor data 608 by projecting a three-dimensional point cloud representation of the environment, a voxel map representation of the environment, etc. based on the first sensor data 603A and/or the second sensor data 603B. The image combination system 604 may associate all or a portion of the pixels of the first sensor data 603A, the second sensor data 603B, and/or the third sensor data to a particular pixel depth based on the first distance data 606A, the second distance data 606B, and/or the third distance data and may map all or a portion of the pixels to the three-dimensional point cloud representation based on the associated pixel depth. The image combination system 604 may project the three-dimensional point cloud representation onto a sphere and unwrap the sphere into the combined sensor data 608.

In some cases, the image combination system 604 may not use (e.g., may not adjust) a radius (e.g., a stitching radius) to generate the combined sensor data 608. The image combination system 603 may project each pixel of the three-dimensional point cloud representation to a particular distance based on the first distance data 606A, the second distance data 606B, and/or the third distance data.

In some cases, the image combination system 604 may use a radius (e.g., a stitching radius) to generate the combined sensor data 608. The sphere may have a variable radius and the image combination system 603 may dynamically adjust the radius of the sphere (e.g., on a pixel by pixel basis) based on the first distance data 606A, the second distance data 606B, and/or the third distance data. For example, the combined sensor data 608 may be a panoramic representation of the environment (e.g., an equirectangular panoramic representation of the environment). In some cases, the image combination system 604 may not use a stitching radius to generate the combined sensor data 608.

In some cases, the image combination system 604 may combine the first sensor data 603A, the second sensor data 603B, and/or the third sensor data to generate the combined sensor data 608 by combining images of the particular sensor data at a seam (e.g., the combined sensor data 608 may include a seam between the images). The image combination system 604 may identify a location for placement of the seam in the combined sensor data (e.g., in between the images) based on the first distance data 606A, the second distance data 606B, and/or the third distance data. For example, using the first distance data 606A, the second distance data 606B, and/or the third distance data, the image combination system 604 may identify one or more pixels of the combined sensor data 608 that are associated with a distance greater than all or a portion of the other distance associated with the other pixels of the combined sensor data. Based on identifying the one or more pixels, the image combination system 604 may move the seam to a location of the one or more pixels. For example, the image combination system 604 may move (e.g., virtually) the seam to the location. In another example, the seam may be fixed relative to the combined sensor data 608 (e.g., fixed in a middle of the sensor data) and the image combination system may instruct movement of the robot 600 (e.g., a leg of the robot 600, an arm of the robot 600, etc.), the first sensor 602A, the second sensor 602B, or a separate system to move (e.g., physically) the seam to the location.

In some cases, the image combination system 604 may generate the combined sensor data 608 using the first distance data 606A, the second distance data 606B, and/or the third distance data. For example, the image combination system 604 may identify a location for placement of a seam within the combined sensor data 608 using the first distance data 606A, the second distance data 606B, and/or the third distance data.

In some cases, the image combination system 604 may adjust (e.g., refine, modify, etc.) the combined sensor data 608 using the first distance data 606A, the second distance data 606B, and/or the third distance data. For example, the image combination system 604 may use the first distance data 606A, the second distance data 606B, and/or the third distance data to identify artifacts within the combined sensor data 608. The image combination system 604 may adjust the combined sensor data 608 by flagging the artifacts within the combined sensor data 608.

The image combination system 604 may route the combined sensor data 608 (e.g., the adjusted combined sensor data) to the computing system 610. The image combination system 604 may instruct display of the combined sensor data 608 via the user interface 612 of the computing system 610 such that the user interface 612 displays the combined sensor data 608. In some cases, the image combination system 604 may instruct display of the adjusted combined sensor data via the user interface 612. In some cases, the image combination system 604 may instruct display of the combined sensor data 608 and an identifier of the identified artifacts or the utilized seam. In some cases, the image combination system 604 may instruct display of an alert indicating the identified artifacts.

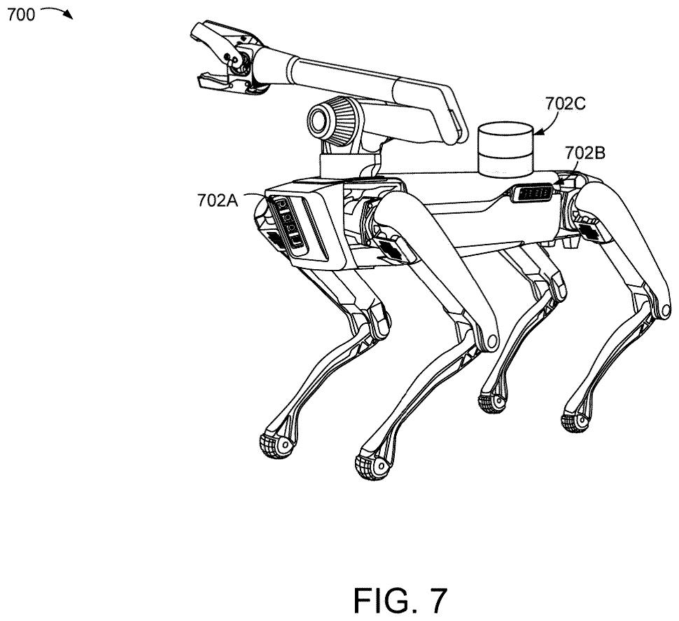

Referring now to FIG. 7, an example robot 700 (e.g., a legged robot) is depicted. The robot 700 may include and/or may be similar to the robot 100 discussed above with reference to FIGS. 1A and 1B. The robot 700 may include a body, one or more legs coupled to the body, an arm coupled to the body, and a set of sensors (e.g., a set of image sensors). In the example of FIG. 7, the set of sensors includes a first set of sensors 702A, a second set of sensors 702B, and a third set of sensors 702C.

All or a portion of the first set of sensors 702A, the second set of sensors 702B, and the third set of sensors 702C may include one or more sensors (e.g., a column of sensors, a row of sensors, etc.). In some cases, all or a portion of the first set of sensors 702A, the second set of sensors 702B, and the third set of sensors 702C may include different types of sensors (e.g., a first type of sensor and a second type of sensor). In some cases, the third set of sensors 702C may include a single sensor and may not include multiple sensors. In the example of FIG. 7, the robot 700 is a quadruped robot with four legs.

As discussed herein, the robot 700 may obtain first sensor data from a first portion of the first set of sensors 702A, the second set of sensors 702B, and the third set of sensors 702C and may obtain second sensor data from a second portion of the first set of sensors 702A, the second set of sensors 702B, and the third set of sensors 702C. For example, the robot 700 may obtain first sensor data from the first set of sensors 702A and may obtain second sensor data from the third set of sensors 702C.

A system may determine first distance data based on the first sensor data and second distance data based on the second sensor data. As discussed herein, the system may use the first distance data and the second distance data to generate combined sensor data and/or adjust previously combined sensor data (e.g., from the second sensor data).

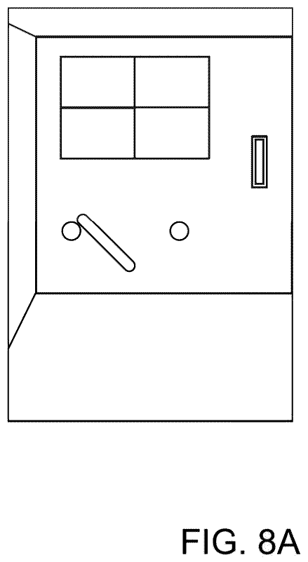

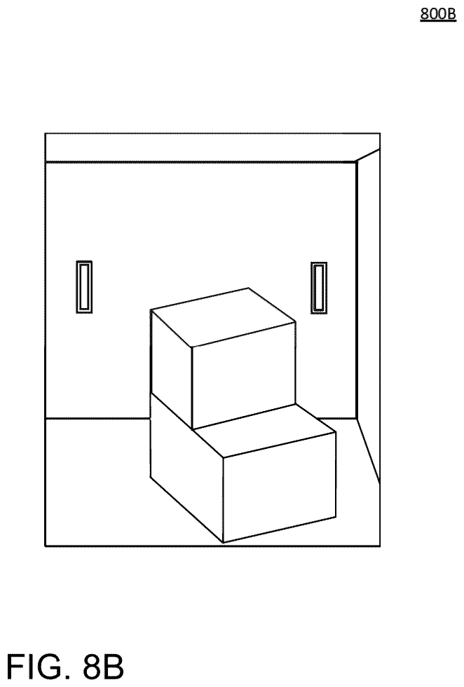

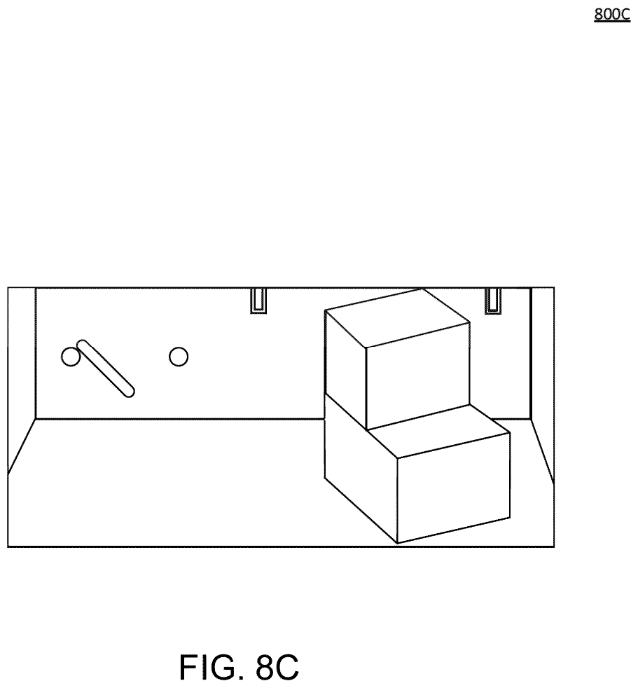

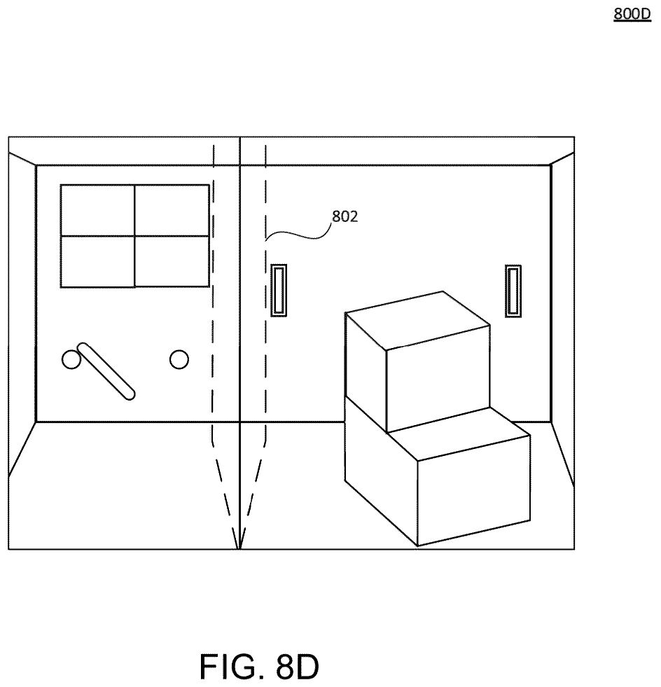

To illustrate an example of sensor data obtained by one or more sensors (e.g., the one or more sensors may include and/or may be similar to the second sensor 602B discussed herein with reference to FIG. 6), FIG. 8A depicts a schematic view 800A of sensor data. In some cases, a computing system (e.g., the computing system 140) may instruct display of a virtual representation of the sensor data via a user interface (of a user computing device).

The sensor data may include image sensor data, lidar sensor data, ladar sensor data, etc. In the example of FIG. 8A, the sensor data includes image sensor data. For example, the sensor data may be an image of a scene within the environment of the robot. The sensor data may indicate a plurality of objects, entities, structures, and/or obstacles in the environment of the robot. In the example of FIG. 8A, the sensor data indicates a first portion of an environment including ground surface, a window, a switch on a wall, a lever on the wall, etc. It will be understood that the environment may include more, less, or different objects, entities, structures, and/or obstacles.

The computing system can obtain data identifying a location, pose, orientation, rotation, translation, etc. of a robot and/or the one or more first sensors. For example, the robot can obtain the data in response to obtaining the sensor data and may associate the sensor data with the data.

As discussed herein, the computing system may obtain distance data based on the sensor data. The distance data may include and/or may be similar to the second distance data 606B discussed herein with reference to FIG. 6.

To illustrate another example of sensor data obtained by one or more sensors (e.g., the one or more sensors may include and/or may be similar to the second sensor 602B discussed herein with reference to FIG. 6), FIG. 8B depicts a schematic view 800B of sensor data. In some cases, a computing system (e.g., the computing system 140) may instruct display of a virtual representation of the sensor data via a user interface (of a user computing device).

The sensor data may include image sensor data, lidar sensor data, ladar sensor data, etc. In the example of FIG. 8B, the sensor data includes image sensor data. For example, the sensor data may be an image of a scene within the environment of the robot. The sensor data may indicate a plurality of objects, entities, structures, and/or obstacles in the environment of the robot. In the example of FIG. 8B, the sensor data indicates a second portion of an environment (relative to the sensor data of FIG. 8A) including a ground surface, an obstacle (e.g., a set of stairs), and two levers on a wall. It will be understood that the environment may include more, less, or different objects, entities, structures, and/or obstacles.

In some cases, the sensor data of FIG. 8A and the sensor data of FIG. 8B may be obtained from the same or different sensors. For example, the sensor data of FIG. 8A may be obtained by a sensor and the sensor data of FIG. 8B may be obtained by the same sensor after a movement of the sensor or the robot. In another example, the sensor data of FIG. 8A may be obtained by a first sensor and the sensor data of FIG. 8B may be obtained by a second sensor where the first sensor and the second sensor have a different location, pose, orientation, rotation, translation, etc.

As discussed herein, the computing system may obtain distance data based on the sensor data. The distance data may include and/or may be similar to the second distance data 606B discussed herein with reference to FIG. 6.

The computing system may identify the sensor data of FIG. 8A and the sensor data of FIG. 8B for combination (e.g., based on a location, pose, orientation, rotation, translation, etc. of the associated sensor(s), based on a request for combined sensor data, etc.). The computing system may confirm that the sensor data of FIG. 8A and the sensor data of FIG. 8B can be combined based on comparing feature points of the sensor data of FIG. 8A and the feature points of the sensor data of FIG. 8B.

To illustrate an example of sensor data used to define the distance data for combining the sensor data of FIG. 8A and the sensor data of FIG. 8B and FIG. 8C depicts a schematic view 800C of sensor data obtained from one or more sensors (e.g., the one or more sensors may include and/or may be similar to the first sensor 602A discussed herein with reference to FIG. 6). In some cases, a computing system (e.g., the computing system 140) may instruct display of a virtual representation of the sensor data via a user interface (of a user computing device).

The sensor data may include image sensor data, lidar sensor data, ladar sensor data, etc. In the example of FIG. 8C, the sensor data includes image sensor data. For example, the sensor data may be an image of a scene within the environment of the robot. The sensor data may indicate a plurality of objects, entities, structures, and/or obstacles in the environment of the robot. In the example of FIG. 8C, the sensor data indicates a third portion of an environment (relative to the sensor data of FIG. 8A and the sensor data of FIG. 8B) including a ground surface, an obstacle (e.g., a set of stairs), a switch on a wall, and a portion of two levers on the wall. It will be understood that the environment may include more, less, or different objects, entities, structures, and/or obstacles.

In some cases, the sensor data of FIG. 8C may be obtained from a first set of sensors and the sensor data of FIG. 8A and the sensor data of FIG. 8B may be obtained from a second set of sensors (e.g., the sensor data of FIG. 8A and the sensor data of FIG. 8B may be obtained from the same or different sensors).

As discussed herein, the computing system may obtain distance data based on the sensor data. The distance data may include and/or may be similar to the first distance data 606A discussed herein with reference to FIG. 6.

To illustrate example combined sensor data, FIG. 8D depicts a schematic view 800D of combined sensor data (e.g., the combined sensor data may include and/or may be similar to the combined sensor data 608 discussed herein with reference to FIG. 6). In some cases, a computing system (e.g., the computing system 140) may instruct display of a virtual representation of the combined sensor data via a user interface (of a user computing device).

The combined sensor data may include image sensor data, lidar sensor data, ladar sensor data, etc. In the example of FIG. 8D, the sensor data includes image sensor data. For example, the sensor data may be an image of a scene within the environment of the robot. The sensor data may indicate a plurality of objects, entities, structures, and/or obstacles in the environment of the robot.

The combined sensor data may be a combination of first sensor data (e.g., the sensor data of FIG. 8A) and second sensor data (e.g., the sensor data of FIG. 8B). As discussed herein, a system may combine the first sensor data and the second sensor data based on distance data (e.g., indicating a distance) associated with sensor data (e.g., a distance based on the sensor data of FIG. 8A, the sensor data of FIG. 8B, and/or the sensor data of FIG. 8C). In the example of FIG. 8D, the sensor data indicates a fourth portion of an environment (relative to the sensor data of FIG. 8A, the sensor data of FIG. 8B, and the sensor data of FIG. 8C) including a ground surface, an obstacle (e.g., a set of stairs), a switch on a wall, a window on the wall, and two levers on the wall. It will be understood that the environment may include more, less, or different objects, entities, structures, and/or obstacles.

The combined sensor data may include a seam 802. As discussed herein, the seam may indicate where the sensor data is combined to generate the combined sensor data. It will be understood that the combined sensor data may include more, less, or different seams. For example, the combined sensor data may include four seams between five images. As discussed herein, a system may dynamically place or move the seam (e.g., by virtually moving the seam, by instructing physical movement of the robot and/or the sensor, etc.).

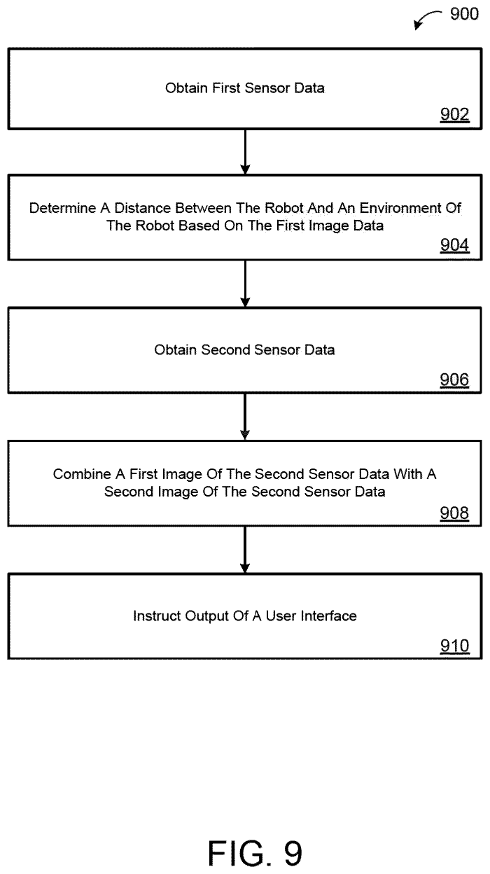

FIG. 9 is a flowchart of an example arrangement of operations for performance by a computing system to combine sensor data. The sensor data may be sensor data associated with a robot. For example, the robot may be a legged robot with a set of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the image combination system 502A and/or the image combination system 502B as discussed herein, and may include memory and/or data processing hardware.

At block 902, the computing system obtains first sensor data (e.g., first image data). The first sensor data may be associated with an environment of the robot. The computing system may obtain the first sensor data from one or more first sensors (e.g., one or more first image sensors) of the robot. For example, the one or more first sensors may include one or more time-of-flight image sensors, one or more lidar sensors, one or more stereo depth image sensors, etc. The field of view of the one or more first sensors may include at least a portion of a ground surface of the environment.

In some cases, the computing system may obtain a first portion of the first sensor data from one or more first sensors and a second portion of the first sensor data from one or more second sensors. The first portion of the first sensor data and the second portion of the first sensor data may be different types of sensor data.

At block 904, the computing system determines a distance (e.g., a first distance) between the robot and an environment of the robot (e.g., at least a portion of the environment) based on the first sensor data. For example, the first sensor data may be distance data (e.g., depth data). In some cases, the computing system may separately receive sensor data indicating the distance.

In some cases, the computing system may determine a second distance between the robot and the environment of the robot (e.g., at least a portion of the environment) based on the first sensor data.

All or a portion of the first distance and/or the second distance may be a distance between a body of the robot, a sensor of the robot (e.g., the one or more first sensors), a leg of the robot, etc. and an obstacle, an object, a structure, an entity, a ground surface, etc. within the environment. In some cases, the computing system may determine the first distance based on a first portion of the first sensor data from a first sensor and may determine the second distance based on a second portion of the first sensor data from a second sensor. The first sensor and the second sensor may have different locations, poses, orientations, rotations, translations, etc.

In some cases, the computing system may generate and/or obtain one or more first maps (e.g., depth maps, voxel maps, spherical depth maps, etc.) based on the first sensor data. The computing system may determine the first distance (and/or the second distance) based on the one or more first maps (e.g., the one or more first maps may indicate the first distance).

At block 906, the computing system obtains second sensor data. The second sensor data may be associated with the environment. In some cases, the second sensor data may be associated with a non-planar scene. In some cases, the first sensor data and the second sensor data may be associated with different portions of the environment.

The computing system may obtain the second sensor data from one or more second sensors (e.g., one or more second image sensors) of the robot. For example, the computing system may obtain the second sensor data from five second image sensors of the robot (e.g., the five second image sensors operating at thirty frames or more per second).

The one or more first sensors may have a first field of view and the one or more second sensors may have a second field of view. In some cases, the first field of view may be a portion of the second field of view. In some cases, the first field of view may include a first portion of the second field of view and exclude a second portion of the second field of view.

In some cases, the computing system may determine a second distance (e.g., a rough distance estimate, a rough depth estimate, etc.) between the robot and the environment of the robot based on the second sensor data. For example, the computing system (or a separate system) may determine the second distance using a monocular depth network. In some cases, the computing system may generate and/or obtain one or more second maps (e.g., depth maps, voxel maps, spherical depth maps, etc.) based on the second sensor data. The computing system may determine the second distance based on the one or more second maps (e.g., the one or more second maps may indicate the second distance). For example, the computing system may generate a first map based on the first sensor data and may obtain a second map based on the second sensor data. The first map may indicate the first distance and the second map may indicate the second distance.

In some cases, the computing system may determine the first distance and/or the second distance based on the first sensor data and the second sensor data. For example, the computing system may determine a scale based on the first sensor data, may adjust the second sensor data (and/or the one or more second maps) based on the scale, and may determine the first distance based on the adjusted second sensor data. In another example, the computing system may determine the distance by revising the second distance (e.g., the rough distance estimate) based on at least one of the first image data, the second image data, the first distance, or the second distance.

In some cases, the one or more first sensors and the one or more second sensors may have different locations, poses, orientations, rotations, translations, etc. For example, the one or more first sensors and the one or more second sensors may be separated by a translation. The field of view of the one or more first sensors may overlap at least in part with a field of view of the one or more second sensors.

In some cases, the one or more second sensors may include multiple sensors that may have different locations, poses, orientations, rotations, translations, etc. For example, the one or more second sensors may include a first sensor (e.g., a first image sensor) and a second sensor (e.g., a second image sensor) and the first sensor and the second sensor may be separated by a translation.

At block 908, the computing system combines (e.g., performs image stitching on) a first portion of the second sensor data (e.g., a first image of the second sensor data from a first image sensor) and a second portion of the second sensor data (e.g., a second image of the second sensor data from a second image sensor or the first image sensor). The combined sensor data may be based on the distance (e.g., the first distance). In some cases, the computing system may combine the first portion and the second portion of the second sensor data based on the distance.

For example, the computing system may combine (e.g., stitch) the first portion and the second portion of the second sensor data to obtain combined sensor data (e.g., combined image data, a combined image, a stitched image, a panoramic image, a panoramic representation of an environment, etc.) and may adjust the combined sensor data based on the distance (e.g., may adjust a distance associated with the combined sensor data). In another example, the computing system may adjust the first portion of the second sensor data and/or the second portion of the second sensor data based on the distance (e.g., may adjust a distance associated with the first portion of the second sensor data and/or a distance associated with the second portion of the second sensor data) and may combine the first portion of the second sensor data (e.g., adjusted or non-adjusted) and the second portion of the second sensor data (e.g., adjusted or non-adjusted).

In some cases, to combine the first portion of the second sensor data and the second portion of the second sensor data, the computing system may project the first portion of the second sensor data and the second portion of the second sensor data onto a three-dimensional representation (e.g., a three-dimensional point cloud data representation) based on the first distance and/or the second distance. For example, the computing system may project the project the first portion of the second sensor data and the second portion of the second sensor data onto a sphere to obtain the three-dimensional representation. The computing system may transform (e.g., unproject, unwrap, etc.) the three-dimensional representation to generate a two-dimensional output (e.g., an equirectangular panorama). For example, the computing system may transform the three-dimensional representation by projecting the three-dimensional representation from the sphere to the two-dimensional output.

The computing system may combine the first portion of the second sensor data and the second portion of the second sensor data based on the one or more maps (e.g., the first map and the second map). For example, the computing system may determine a plurality of distances (e.g., based on the one or more maps). All or a portion of the plurality of distances (e.g., which may include the first distance, the second distance, etc.) may indicate a measurement of a respective distance (e.g., depth) from the robot and to a respective at least a portion of the environment based on at least one of the first sensor data or the second sensor data.

The computing system may combine the first portion of the second sensor data and the second portion of the second sensor data based on the plurality of distances. For example, the computing system may use the plurality of distances to place a seam between portions of sensor data, to identify pixel depths for the combined sensor data, etc. Using the plurality of distances, the computing system may automatically move the seam and/or may automatically pixel depths according to the identified pixel depths.

The first portion of the second sensor data and the second portion of the second sensor data may overlap at least in part (e.g., a portion of the first image overlaps with a portion of the second image). The computing system may combine the first portion of the second sensor data and the second portion of the second sensor data based on the overlap. Further, the combined sensor data may include a seam between the first portion of the second sensor data and the second portion of the second sensor data based on the overlap.

In some cases, the computing system may identify the seam and move the seam between the first portion of the second sensor data and the second portion of the second sensor data based on the plurality of distances (e.g., such that the seam corresponds to a portion of the environment). For example, the computing system may determine that a first portion of the environment is further from the robot as compared to a second portion of the environment.

The computing system may move (e.g., virtually) the seam between the first portion of the second sensor data and the second portion of the second sensor data from corresponding to the second portion of the environment to corresponding to the first portion of the environment based on the determining that the first portion of the environment is further from the robot as compared to the second portion of the environment.

In some cases, to move the seam, the computing system may instruct movement, in real-time, of the one or more first sensors and/or the one or more second sensors, such that the seam is moved to correspond to a portion of the environment. In some cases, the computing system may instruct movement of the one or more first sensors and/or the one or more second sensors as the robot navigates the environment.

In some cases, to move the seam, the computing system may instruct movement, in real-time, of the robot (e.g., a leg of the robot, an arm of the robot, a joint of robot, etc.), such that the seam is moved to correspond to a portion of the environment. For example, the computing system may determine a position, orientation, pose, etc. of the robot to move the seam to correspond to the portion of the environment and may instruct movement of the robot such that the position, orientation, pose, etc. corresponds to the determined position, orientation, pose, etc.

In some cases, the computing system may cause movement of a seam between a first portion of the first sensor data and a second portion of the first sensor data (e.g., a first image and a second image). The computing system may obtain the second sensor data based on causing movement of the seam and may combine portions of the second sensor data (e.g., a third image and a fourth image) to obtain the combined sensor data.

In some cases, the computing system may generate a third map based on the one or more maps (e.g., the first map and the second map). For example, the computing system may determine one or more mapping parameters (e.g., a scale, an orientation, obstacles, entities, structures, and/or objects in the environment, etc.) based on the one or more maps and may use the one or more mapping parameters to generate the third map. In some cases, the computing system may determine a correlation between the one or more first sensors and the one or more second sensors. The computing system may correlate the one or more maps based on the determined correlation and may determine the one or more mapping parameters and generate the third map based on correlating the one or more maps. The computing system may combine the first portion of the second sensor data and the second portion of the second sensor data based on the third map.

In some cases, the first portion of the second sensor data and the second portion of the second sensor data (e.g., the combination of the first portion of the second sensor data and the second portion of the second sensor data) may cause one or more artifacts. For example, the combination of the first portion of the second sensor data and the second portion of the second sensor data may cause a parallax effect.

In some cases, the computing system may generate an alert associated with the combined sensor data based on the first distance. For example, the alert may indicate one or more artifacts, may flag a portion of the combined sensor data, etc. In some cases, the computing system may cause display of the alert (e.g., via a user computing device).

In some cases, the computing system may filter the first portion of the second sensor data and/or the second portion of the second sensor data (e.g., filter a portion of a first image and/or filter a portion of a second image) based on the first distance (e.g., based on placement of the seam according to the distance) to obtain a filtered portion of the second sensor data (e.g., a filtered first image and/or a filtered second image). To combine the first portion of the second sensor data and the second portion of the second sensor data, the computing system may combine a first portion of the second sensor data as filtered by the computing system and the second portion of the second sensor data. For example, the computing system may combine a filtered first image and a non-filtered second image. In another example, the computing system may combine a filtered first image and a filtered second image.

In some cases, the computing system may combine the sensor data based on the first distance and/or the second distance. In some cases, the computing system may compare the first distance and the second distance. For example, the computing system may determine that the first distance is different from the second distance based on the comparison and may combine the sensor data using the first distance based on determining that the first distance is different from the second distance. In another example, the computing system may verify (e.g., validate) the second distance based on the comparison and may combine the sensor data using the second distance based on the verification.

In some cases, the computing system may determine a third distance based on the first distance and the second distance. For example, the computing system may average the first distance and the second distance to determine the third distance. In another example, the computing system may determine a scale based on the first distance and may adjust the second distance using the scale to determine the third distance. The computing system may combine the sensor data based on the third distance.

In some cases, to determine the second distance, the computing system may combine the first portion of the second sensor data and the second portion of the second sensor data to obtain the combined sensor data and the computing system may determine the second distance based on the combined sensor data as discussed herein.

At block 910, the computing system instructs output of a user interface. For example, the computing system may instruct display of the combined sensor data via the user interface. In another example, the computing system may instruct display of an alert based on the combined sensor data. In another example, the computing system may instruct display of an equirectangular panorama as discussed herein.

In some cases, the computing system may instruct movement of the robot (e.g., based on the output of the user interface, based on the combined sensor data, etc.). For example, the computing system may receive an input based on the output of the user interface (e.g., a user may interact with the user interface to provide an input). The input may include a selection of an action (e.g., capture sensor data, navigate an environment, etc.), a selection of a portion of the environment for navigation, etc. based on the combined sensor data. In response to the input, the computing system may instruct movement of the robot (e.g., to perform the action, to navigate to a portion of the environment, etc.).

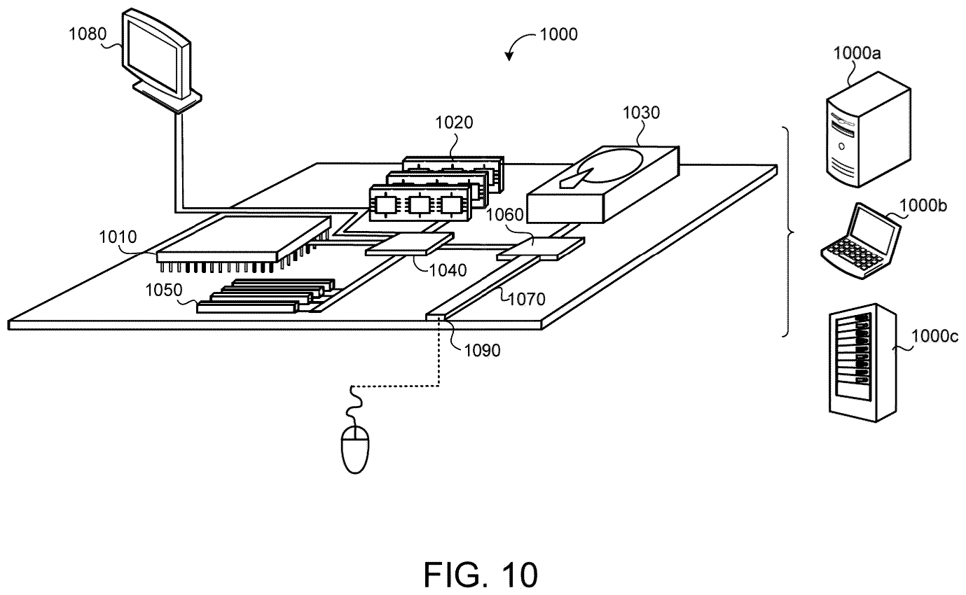

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020, a storage device 1030, a high-speed interface/controller 1040 connecting to the memory 1020 and high-speed expansion ports 1050, and a low-speed interface/controller 1060 connecting to a low speed bus 1070 and a storage device 1030. All or a portion of the processor 1010, the memory 1020, the storage device 1030, the high-speed interface/controller 1040, the high-speed expansion ports 1050, and the low-speed interface/controller 1060, may be interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to the high-speed interface/controller 1040. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1020 (e.g., non-transitory memory) may store information non-transitorily within the computing device 1000. The memory 1020 may be a computer-readable medium, a volatile memory unit(s), or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 may provide mass storage for the computing device 1000. In some implementations, the storage device 1030 may be a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high-speed interface/controller 1040 may manage bandwidth-intensive operations for the computing device 1000, while the low-speed interface/controller 1060 may manage lower bandwidth-intensive operations. Such allocation of duties is exemplary only. In some implementations, the high-speed interface/controller 1040 may be coupled to the memory 1020, the display 1080 (e.g., through a graphics processor or accelerator), and to the high-speed expansion ports 1050, which may accept various expansion cards (not shown). In some implementations, the low-speed interface/controller 1060 may be coupled to the storage device 1030 and a low-speed expansion port 1090. The low-speed expansion port 1090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers, as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user. In certain implementations, interaction is facilitated by a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described above can be combined to provide further embodiments. Indeed, the methods and systems described herein may be embodied in a variety of other forms; furthermore, various omissions, substitutions, and changes in the form of the methods and systems described herein may be made without departing from the spirit of the disclosure. Accordingly, other implementations are within the scope of the following claims.

What is claimed is:

1. A method comprising:
obtaining, by data processing hardware of a robot, sensor data associated with an environment of the robot;
determining, by the data processing hardware, a distance between the robot and at least a portion of the environment based on the sensor data;
obtaining, by the data processing hardware, image data associated with the environment, the image data comprising a first image and a second image;
combining, by the data processing hardware, the first image and the second image to obtain combined image data, wherein the combined image data is based on the distance; and
instructing, by the data processing hardware, output of a user interface based on the combined image data.

2. The method of claim 1, further comprising:
adjusting the combined image data based on the distance.

3. The method of claim 1, further comprising:
adjusting a third image based on the distance to obtain the first image or the second image.

4. The method of claim 1, further comprising:
generating an alert associated with a portion of the first image or a portion of the second image based on the distance.

5. The method of claim 1, wherein the distance comprises a first distance, the method further comprising:
determining a second distance between the robot and the at least a portion of the environment based on the sensor data;
comparing the first distance and the second distance; and
verifying the second distance based on comparing the first distance and the second distance,
wherein combining the first image and the second image based on verifying the second distance.

6. The method of claim 1, wherein the distance comprises a first distance, the method further comprising:
generating a first map based on the sensor data, wherein the first map indicates the first distance; and
obtaining a second map based on the image data, wherein the second map indicates a second distance, wherein combining the first image and the second image is based on the first map and the second map.

7. The method of claim 1, further comprising:
determining a plurality of distances, wherein each distance of the plurality of distances comprises a measurement of a respective depth from the robot and to a respective at least a portion of the environment based on at least one of the sensor data or the image data, wherein the plurality of distances comprises the distance, and wherein the combined image data is based on the plurality of distances.

8. The method of claim 1, further comprising:
generating a first map based on the sensor data, wherein the first map indicates a first distance; and
obtaining a second map based on at least one of the sensor data or the image data, wherein the second map indicates a rough distance estimate, wherein the rough distance estimate is generated by a monocular depth network,
wherein determining the distance comprises:
revising the rough distance estimate based on at least one of the sensor data, the image data, the first distance, or a second distance.

9. The method of claim 1, wherein obtaining the sensor data comprises:
obtaining the sensor data from one or more first image sensors of the robot, and wherein obtaining the image data comprises:
obtaining the image data from one or more second image sensors of the robot, the method further comprising:
generating a first map based on the sensor data, wherein the first map indicates a first distance;
obtaining a second map based on the image data, wherein the second map indicates a second distance;
determining a correlation between the one or more first image sensors and the one or more second image sensors;
correlating the first map and the second map based on the correlation between the one or more first image sensors and the one or more second image sensors;
determining one or more mapping parameters based on correlating the first map and the second map; and
generating a third map based on the one or more mapping parameters, wherein the combined image data is based on the third map.

10. The method of claim 1, wherein combining the first image and the second image comprises:
projecting the first image and the second image onto a three-dimensional representation based on the distance; and
generating an equirectangular panorama based on projecting the first image and the second image onto the three-dimensional representation, wherein the user interface comprises the equirectangular panorama.

11. The method of claim 1, wherein the at least a portion of the environment comprises a first portion of the environment, wherein obtaining the image data comprises:
obtaining the first image from a first image sensor and the second image from a second image sensor,
the method further comprising:
determining that the first portion of the environment is further from the robot as compared to a second portion of the environment; and
instructing movement of the robot such that a seam between the sensor data and the image data corresponds to the first portion of the environment.

12. The method of claim 1, wherein obtaining the image data comprises:
obtaining the first image from a first image sensor and the second image from a second image sensor,
the method further comprising:
instructing movement, in real-time, of at least one of the first image sensor or the second image sensor as the robot navigates the environment such that a seam between the first image and the second image corresponds to the at least a portion of the environment.

13. The method of claim 1, wherein obtaining the sensor data comprises:
obtaining the sensor data from one or more first image sensors of the robot, and wherein obtaining the image data comprises:
obtaining the image data from one or more second image sensors of the robot.

14. The method of claim 1, wherein obtaining the sensor data comprises:
obtaining the sensor data from a first image sensor of the robot, and wherein the distance comprises a distance between the first image sensor and the at least a portion of the environment.

15. The method of claim 1, wherein obtaining the sensor data comprises:
obtaining the sensor data from at least one of a time-of-flight image sensor, a lidar sensor, or a stereo depth image sensor.

16. The method of claim 1, wherein obtaining the image data comprises:
obtaining the first image from a first image sensor and the second image from a second image sensor, wherein a field of view of the first image sensor overlaps with a field of view of the second image sensor.

17. The method of claim 1, wherein obtaining the image data comprises:
obtaining the first image from a first image sensor and the second image from a second image sensor, wherein the first image sensor and the second image sensor are separated by a translation.

18. The method of claim 1, wherein combining the first image and the second image comprises:
stitching the first image and the second image.

19. The method of claim 1, further comprising:
generating a map based on the sensor data, wherein the map indicates the distance.

20. A system comprising:
data processing hardware; and
memory in communication with the data processing hardware, the memory storing instructions that when executed on the data processing hardware cause the data processing hardware to:
obtain sensor data associated with an environment of a robot;
determine a distance between the robot and at least a portion of the environment based on the sensor data;
obtain image data associated with the environment, the image data comprising a first image and a second image;
combine the first image and the second image to obtain combined image data, wherein the combined image data is based on the distance; and
instruct output of a user interface based on the combined image data.

21. The system of claim 20, wherein the at least a portion of the environment comprises a first portion of the environment, wherein to obtain the image data, execution of the instructions on the data processing hardware further causes the data processing hardware to:
obtain the first image from a first image sensor and the second image from a second image sensor,
wherein the execution of the instructions on the data processing hardware further causes the data processing hardware to:
determine that the first portion of the environment is further from the robot as compared to a second portion of the environment; and
instruct movement of at least one of the first image sensor or the second image sensor such that a seam between the first image and the second image corresponds to the first portion of the environment.

22. The system of claim 20, wherein the distance comprises a first distance, wherein execution of the instructions on the data processing hardware further causes the data processing hardware to:
generate a first map based on the sensor data, wherein the first map indicates the first distance;
obtain a second map based on the image data, wherein the second map indicates a second distance;
determine one or more mapping parameters based on the first map and the second map; and
generate a third map based on the one or more mapping parameters, wherein the combined image data is based on the third map.

23. A robot comprising:
data processing hardware; and
memory in communication with the data processing hardware, the memory storing instructions that when executed on the data processing hardware cause the data processing hardware to:
obtain sensor data associated with an environment of the robot;
determine a distance between the robot and at least a portion of the environment based on the sensor data;
obtain image data associated with the environment, the image data comprising a first image and a second image;
combine the first image and the second image to obtain combined image data, wherein the combined image data is based on the distance; and
instruct output of a user interface based on the combined image data.

24. The robot of claim 23, wherein to obtain the sensor data, execution of the instructions on the data processing hardware further causes the data processing hardware to:
obtain the sensor data from one or more first image sensors of the robot, and
wherein to obtain the image data, the execution of the instructions on the data processing hardware further causes the data processing hardware to:
obtain the image data from one or more second image sensors of the robot, wherein the distance comprises a first distance, wherein the one or more first image sensors have a first field of view, wherein the one or more second image sensors have a second field of view, and wherein the first field of view includes a first portion of the second field of view and excludes a second portion of the second field of view,
wherein the execution of the instructions on the data processing hardware further causes the data processing hardware to:
generate a first map based on the sensor data, wherein the first map indicates the first distance;
obtain a second map based on the image data, wherein the second map indicates a second distance; and
generate a third map based on the first map and the second map, wherein the combined image data is based on the third map.

25. The robot of claim 23, wherein to obtain the sensor data, execution of the instructions on the data processing hardware further causes the data processing hardware to:
obtain the sensor data from a first image sensor of the robot, and wherein a field of view of the first image sensor comprises at least a portion of a ground surface of the environment.
